(19) United States
(12) Patent Application Publication
(10) Pub. No.: US 2006/0075001 A1
(43) Pub. Date: Apr. 6, 2006

(54) System, method and program to distribute program updates

(76) Inventors: Jeffrey Craig Canning, Highlands Ranch, CO (US); Erik R. Johnson, Longmont, CO (US); Lynda Y. Slavens, Eric, CO (US)

Correspondence Address: IBM CORPORATION, IPLAW IQ0A/40-3, 1701 NORTH STREET, ENDICOTT, NY, 13760, US

(21) Appl. No.: 10/957,310

(22) Filed: Sep. 30, 2004

(51) Int. Cl. G06F 17/30

(52) U.S. Cl. 707/203

(57) ABSTRACT

System, method and computer program for distributing updates to software in a plurality of client servers. A client management server includes a first program to determine what updates to the software are needed for installation at each of the client servers. A distribution server obtains the needed software updates from one or more software vendors and furnishes the needed software updates to the client management server. The client management server further includes a second program to install the needed software updates at the client servers, a third program to determine what updates to the first program are needed for installation at the client management server, and a fourth program to install the needed program updates at the client management server. The distribution server furnishes the needed program updates to the client management server. Staging or installation of the software updates can be simulated and the simulation results displayed to a user before the actual staging or installation of the software updates. After installation of the software updates, the client servers can be rebooted at different times to maintain availability of the software to users.

### BACKGROUND OF THE INVENTION

The present invention relates generally to computer systems, and deals more particularly with a technique to provide software updates to computers.

It is known to automatically distribute software updates to computers in a variety of manners. For example, U.S. Pat. No. 5,752,042 entitled “Server Computer for Selecting Program Updates for a Client Computer Based on Results of Recognizer Program(s) furnished to the Client Computer” to Cole et al. discloses the following. A server computer identifies code updates which are consistent with basic system characteristics of a client computer. Then, the server computer sends to the client computer one or more “recognizer” programs which execute in the client computer to determine whether the client computer has a version other than a current version of the identified code updates. The client computer sends the results to the server computer which generates a list of code updates which are consistent with the basic system characteristics, representing programs that exist on the client computer for which an update would be appropriate. Next, the server computer sends the list to the client computer. A user at the client computer selects from the list and sends the selections to the server computer. In response, the server computer sends addresses of the selected code updates to the client computer, and the client computer downloads the selected code updates from a content server. See also U.S. Pat. No. 6,074,434 entitled “Selection of Code Updates, Data Updates or New Data for Client” to Cole et al.

It is known for a client computer to interact with a software update service via the Internet to identify software updates that the client computer needs. The client computer includes an agent program which determines what software versions currently reside on the client computer and then compares those to the latest versions/updates available from the software vendor. Then, the agent program notifies the user of the client computer that a software update is available from the update service. If the user selects the software update, the agent program installs the software update on the client computer.

An IBM Standard Software Installer (ISSI) software update delivery program is also known. A known IBM EZUpdate program tool is an enhancement to the ISSI tool. The EZUpdate tool automatically prompts the user to install application updates and software fixes to the user's workstation. The ISSI EZUpdate Service runs in the background on the user's workstation. It requires an agent (a Microsoft Windows service) to be installed on the user's workstation. It periodically wakes up to initiate a scan for applications or updates which are not installed on the user's workstation, but which are monitored and available from ISSI. Once an application and its version are identified, it is checked against a list of updates on ISSI. If any such applications or updates are found, the ISSI EZUpdate user interface will be started to present the user with a list from which the user can choose what to install immediately and what to defer until a later time. In this list, those applications which the user is required to install are marked with a red exclamation point. Other applications in the list are recommended, but the user is not required to install them. As applications and/or critical updates are applied to the user's workstation, this information is recorded in the user's workstation registry. The ISSI EZUpdate program compares this information with the list of updates maintained by ISSI to determine if any updates are needed. If no updates are available, the agent is not activated until the next cycle.

An object of the present invention is to automate the process of distributing software updates to client computers.

Another object of the present invention is to control of the process of distributing software updates to client computers.

### SUMMARY OF THE INVENTION

The invention resides in a system, method and computer program for distributing updates to software in a plurality of client servers. A client management server includes a first program to determine what updates to the software are needed for installation at each of the client servers. A distribution server obtains the needed software updates from one or more software vendors and furnishes the needed software updates to the client management server. The client management server further includes a second program to install the needed software updates at the client servers, a third program to determine what updates to the first program are needed for installation at the client management server, and a fourth program to install the needed program updates at the client management server. The distribution server furnishes the needed program updates to the client management server.

The invention also resides in a system, method and computer program for simulating distribution of updates to software in a plurality of client servers. A client management server includes a first program to determine what software is supported in each of the client servers and a second program to determine what updates to the software are needed for installation at each of the client servers. A distribution server obtains the needed software updates from one or more software vendors and furnishes the needed software updates to the client management server. The client management server further includes a third program to determine if the needed software updates obtained from the distribution server are authentic. The client management server further includes a fourth program to log results of the determination by the first program of what software is supported in each of the client servers and results of the determination by the third program if the needed software updates obtained from said distribution server are authentic. The fourth program displays the log to a user before the needed software updates are installed in the client servers, and allows the user to avoid the installation based on the log.

The invention also resides in a system for distributing updates to common software in a group of client servers. A client management server includes a first program to determine what updates to the common software are needed for installation at each of the client servers in the group. A distribution server obtains the needed software updates from one or more software vendors and furnishes the needed software updates to the client management server. The client management server further includes a second program to install the needed software updates at the client servers in the group. The second program automatically reboots at different times the client servers in the group to activate the installed, needed software updates such that all of the client servers in the group are not rebooting at the same time, whereby availability of the common software to users from at least one of the client servers in the group is maintained.

### BRIEF DESCRIPTION OF THE FIGURES

FIG. 1 is a block diagram of a distributed computer system which embodies the present invention.

FIG. 2 is a flow chart of site management program or exec, called Patch.exe, which executes on a Site Server of the computer system of FIG. 1 according to the present invention.

FIG. 3 is a flow chart of a master distribution program or exec, called Down.exe, which executes on a Master Distribution Server of the computer system of FIG. 1 according to the present invention.

FIG. 4 is a flow chart of a client access program or exec, called Access.exe, which executes on the Site Server of the computer system of FIG. 1 according to the present invention.

FIG. 5 is a flow chart of a distribute client configuration program or exec, called DConfig.exe, which executes on the Site Server of the computer system of FIG. 1 according to the present invention.

FIG. 6 is a flow chart of a version checking program or exec, called VCheck.exe, which executes on the Site Server of the computer system of FIG. 1 according to the present invention.

FIG. 7 is a flow chart of a client reporting program or exec, called Report.exe, which executes on the Site Server of the computer system of FIG. 1 according to the present invention.

FIG. 8 is a flow chart of a client exec staging program or exec, called Stage.exe, which executes on the Site Server of the computer system of FIG. 1 according to the present invention.

FIG. 9 is a flow chart of a client software update installation program or exec, called Install.exe, which executes on the Site Server of the computer system of FIG. 1 according to the present invention.

FIG. 10 is a flow chart of a client software update removal program or exec, called Remove.exe, which executes on the Site Server of the computer system of FIG. 1 according to the present invention.

FIG. 11 is a flow chart of a remote client server rebooting program or exec, called Reboot.exe, which executes on the Site Server of the computer system of FIG. 1 according to the present invention.

FIG. 12 is a flow chart of a client file collection program or exec, called Collect.exe, which executes on the Site Server of the computer system of FIG. 1 according to the present invention.

FIG. 13 is a flow chart of a Site repo detailing program or exec, called Detail.exe, which executes on the Site Server of the computer system of FIG. 1 according to the present invention.

FIG. 14 is a flow chart of a Site matrix reporting program or exec, called Matrix.exe, which executes on the Site Server of the computer system of FIG. 1 according to the present invention.

FIG. 15 is a flow chart of a remote client server maintenance program or exec, called Maint_C.exe, which executes on Remote Client Servers of the computer system of FIG. 1 according to the present invention.

FIG. 16 is a flow chart of a Site Server maintenance program or exec, called Maint_S.exe, which executes on the Site Server of the computer system of FIG. 1 according to the present invention.

FIG. 17 is a flow chart of a multiple Site report rollup program or exec, called Rollup.exe, which executes on the Site Server of the computer system of FIG. 1 according to the present invention.

FIG. 18 is a flow chart of a Site Server software updating program or exec, called Update.exe, which executes on the Site Server of the computer system of FIG. 1 according to the present invention.

FIG. 19 is a more detailed flow chart of the site management/Patch program or exec of FIG. 2.

FIG. 20 is a flow chart of a license key checking program or exec, called KeyCheck.exe, which is invoked by the Down.exe program or exec and executes on the Master Distribution Server of the computer system and which is invoked by the Patch.exe program or exec and executes on the Site Server of the computer system of FIG. 1 according to the present invention.

FIG. 21 is a flow chart of an initializing INI program, called InitializelNI process, which is called in Patch that executes on the Site Server of the computer system of FIG. 1 according to the present invention.

FIG. 22 is a flow chart of a version checking process, called DoServerVersionCheck program, which is called in Patch.exe that executes on the Site Server of the computer system of FIG. 1 according to the present invention.

FIG. 23 is a flow chart of an exec launching program, called DoModeLaunch program process, which is called in Patch program, that executes on the Site Server of the computer system of FIG. 1 according to the present invention.

FIG. 24 is an example of a text report generated by the Detail.exe program or exec.

FIG. 25 is an example of an HTML report generated by the Matrix.exe program or exec.

FIG. 26 is a block diagram of an alternate embodiment of the distributed computer system of FIG. 1 according to the present invention.

FIG. 27 is a block diagram of part of an alternate embodiment of the distributed computer system of FIG. 1 according to the present invention FIG. 28 is an example of the command line options available for the Patch program or exec.

FIG. 29 is an example of a log generated by the Stage.exe program when a simulation option is used.

FIG. 30 is an example of a log generated by the Install.exe program when the simulation option is used.

FIG. 31 is an example of a log generated by the Remove.exe program when the simulation option is used.

FIG. 32 is an example of a log generated by the Reboot.exe program when the simulation option is used.

### DETAILED DESCRIPTION OF THE PREFERRED EMBODIMENTS

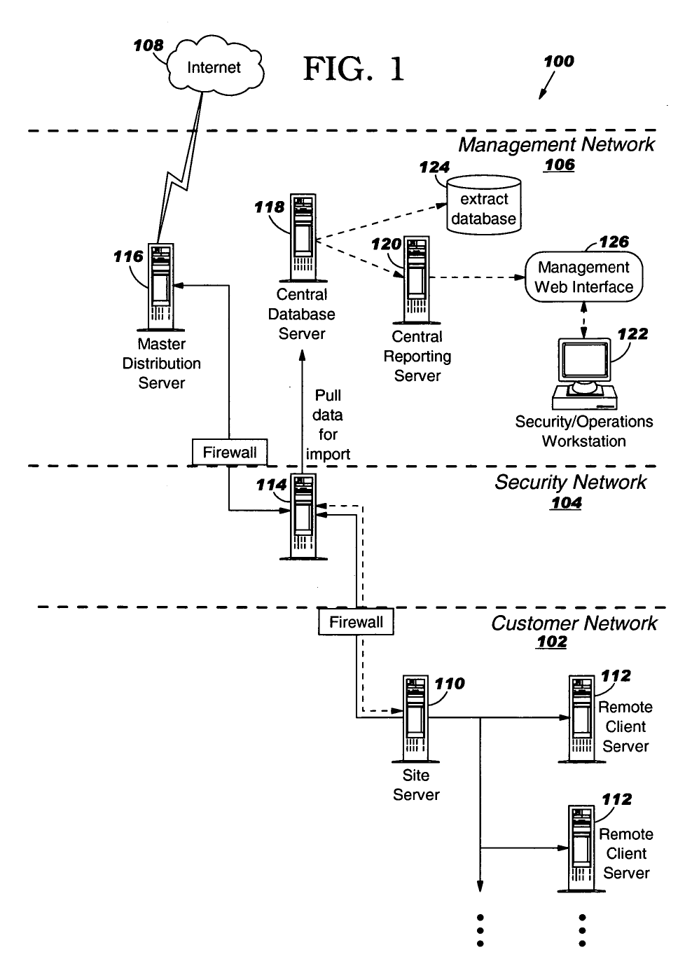

The present invention will now be described in detail with reference to the figures, wherein like reference number indicate like elements throughout. FIG. 1 illustrates a distributed computer system generally designated 100 in which the present invention is incorporated. System 100 is connected to the Internet 108 via local networks or intranet. By way of example, system 100 comprises a customer network 102, a security network 104 and a management network 106. The management network 106 includes a Central Database Server (CDS) 118 coupled to one of more external databases 124, Central Reporting Server (CRS) 120 coupled to the Central Database Server, Management Web Interface 126, and one or more Operations/Security workstations 122. The management network 106 also includes a Master Distribution Server (“MDS”) 116 which authenticates requests for software updates and distributes the software updates. The Master Distribution Server contains all the possible hotfixes, software patches, service packs and control programs and execs that may need to be downloaded to the customer network 102. The Central Database Server provides a central repository for all client and Site data for multiple customer networks and Sites, and provides the interface to external database systems. The Central Reporting Server 120 provides the interface between the Operations/Security workstations and the Central Database Server to provide reports, statistics, trending, and vulnerability compliance across multiple customer networks and Sites. The Operations/Security workstations 122 are used by Delivery Compliance Administrators (DCA) to monitor and report vulnerability compliance across multiple customer networks and Sites.

The Master Distribution Server maintains current information of the latest security hotfixes, patches, and service packs available from the vendors as follows, so the Patch program can determine what software updates each Remote Client Server needs, and the Install exec can automatically install these software updates. The Master Distribution Server 118 downloads from the software vendors (such as from a Microsoft web site) files which include the latest software updates. For example, the Master Distribution Server 118 can query the software vendor web site every day to seek new software updates. When the software vendor is Microsoft Corporation, these files are called mssecure.cab and hfnetchk.cab. Microsoft Corporation updates these files and makes them available via the Internet 108 to the Master Distribution Server 118 (and all other subscribers) every time Microsoft releases a new Security Bulletin. Then, the Master Distribution Server 118 downloads these files from the vendor, and pushes these files to the Web Reporting Server 114 (for example, on a daily basis). Then, the Web Reporting Server pushes these files to the Site Server 110 (for example, on a daily basis). A program or exec (such as hfnetchk.exe from Shavlic Technologies) within the Site Server periodically scans the Remote Client Servers to determine the latest versions of software that they have and supplies this information to the Site Server 110. Then, the program or exec within the Site Server compares these versions to the latest ones obtained from the vendor. If the Remote Client Server does not have the latest version, but supports the latest version, then the Site Server 110 automatically installs these software update files on the Remote Client Servers 112 as described in more detail below.

The Master Distribution Server 116 operates as follows. The Master Distribution Server 116 verifies that a license key supplied with the Down exec is valid and not expired. If the license key is not valid, then the Master Distribution Server will not install the Down exec (if it is not already installed). If the Down exec is installed pursuant to a valid license key, but the license key subsequently expires, then the Master Distribution Server will no longer execute the Down exec. By way of example, the Master Distribution Server 116 generates 160-bit MD5 fingerprints for all module files, hotfixes, patches, and service packs, encrypts the resulting MD5 fingerprints using AES 256-bit symmetric encryption, and digitally signs software update files to be downloaded to the Site Server via the Web Reporting Server using GnuPG 2048-bit asymmetric encryption. The Master Distribution Server also generates required parameters (for example, /C:“msiexec/I Q 123456.msp/Q”,/quiet/noresta/passive, and /Q:A/R:N) for the security hotfixes and patches. The Master Distribution Server 116 then downloads security “hot fix” update software packages, software patches, and software service packs that are needed by the Remote Client Servers. The Master Distribution Server 116 also downloads updates for control programs/execs 200 and 400-1800 used by the Site Server 110 to distribute the foregoing software updates to the Remote Client Computers 112 and monitor the installation.

As for the control programs/execs 200 and 400-1800 used by the Site Server to manage updates to the software resident on the Remote Client Server, the developer of the execs used by the Site Server loads updates to these execs into the Master Distribution Server. (Alternately, the Master Distribution Server can obtain these updates automatically via the Internet by periodically querying the developing web site or by the developing web site pushing these updates to the Master Distribution Server via the Internet when the updates are become available.) The Master Distribution Server then pushes these updates to the Web Reporting Server, and the Web Reporting Server then pushes these updates to the Site Server. The Site Server Patch Program 200 DoServerVersionCheck program process 2200 compares the versions of the execs currently resident on Site Server or which have been copied by the Site Server to the Remote Client Servers to the versions of the execs represented by the latest updates downloaded from the Master Distribution Server via the Web Reporting Server. Then, the DoServerVersionCheck program process 2200 exec in the Site Server automatically installs into the Site Server any new/needed updates to the execs 200 and 400-1800.

Thus, in addition to identified software updates, the Master Distribution Server 116 is also the distribution point for the developer to release control program/exec updates that will be pushed down via the Web Reporting Server 114 to the Site Server 110 or downloaded by the Site Server directly by using the Patch Program Update exec (step 1818). Once the control program/execs are on the defined location on the Site Server (for example, D:\Tools\Updates\PatchProgram), the Patch Program 200 will perform a version check and an automatic self update of the valid control program/execs on the Site Server (applicable to the control program/execs 200 and 400-1800). Then, the Patch Program Vcheck exec 600 performs a version check between the control program/exec files in the updates location on the Site Server with the Remote Client Servers and will update the valid control program/exec files as needed (this is only applicable to the Report exec 700) to ensure the Remote Client Server has the same version of this exec as the Site Server.

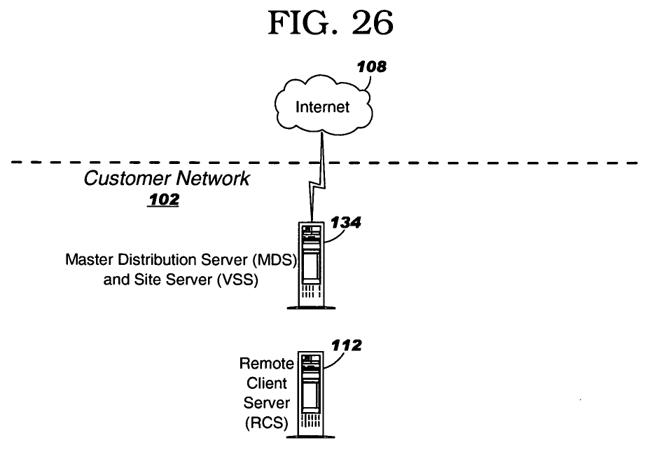

As for the updates to the software resident in the Remote Client Servers, in the example shown in FIG. 1, the Master Distribution Server “pushes” all such digitally signed security hotfixes, software patches, service packs and control program/exec updates to a Web Reporting Server (WRS) 114 in the security network 104 using OpenSSH. The Web Reporting Server 114 uses the information generated by the Matrix exec to obtain the list of software updates (identified by Qnumber or other identifier) needed by all Remote Client Servers of the Customer Site. The Web Reporting Server will “push” the digitally signed files for the identified software updates to the Site Server 110 using OpenSSH for later staging and installation at the Remote Client Servers. The Patch Program Stage exec 800 performs a version check between each identified software update for the Remote Client Server and the available identified software update on the Site Server and Stages the software update to the Remote Client Server if needed. In the example shown in FIG. 26, the Update exec 1800 uses information generated by the Matrix exec to obtain the list of software updates (identified by Qnumber or other identifier) needed by all Remote Client Servers of the Customer Site. Update exec 1800 will download the digitally signed files for the identified software updates from the Master Distribution Server 116 directly to the Site Server 110 for later staging and installation at the Remote Client Servers.

The Web Reporting Server 114 is coupled to the Master Distribution Server 116 via the Management Network 106 and Security Network 104. The Security Network 104 employs firewalls, port filtering, and intrusion detection. The Web Reporting Server (“WRS”) 114 in the Security Network 104 uses the software update information provided by the Site Server 110 Patch Program 200 Matrix exec 1400 to determine which updates the respective Site Server needs for its Remote Client Servers 112. Then, the Web Reporting Server verifies and “pushes” the identified digitally signed security hotfixes, software patches, service packs and control program and exec updates received from the Master Distribution Server to the Site Server (“VSS”) 110 in the customer network 102. The Web Reporting Server obtains these software files from Master Distribution Server 116 in the management network 106. The Web Reporting Server also distributes client specific configuration settings and exceptions to the Site Server. The Web Reporting Server also “pulls” reports and data from the Site Server using OpenSSH. The Web Reporting Server uses the pulled reports and data to display the information via a web interface and provide the data in a format that can be pulled for import by the Central Database Server.

The customer network 102 includes the Site Server 110 and many Remote Client Servers 112, although FIG. 1 specifically illustrates only two such Remote Client Servers 112. The Site Server and Remote Client Servers are coupled to the Web Reporting Server 114 via the Security Network 104 and Customer Network 102. The Customer Network 102 employs firewalls, port filtering, and intrusion detection. The Site Server 110 performs control, management, and communication functions such as the following. The Site Server 110 verifies connectivity and access to the Remote Client Servers. The Site Server is capable of communicating with multiple Remote Client Servers concurrently, and generates the client configuration settings at runtime. The Site Server also provides a command line interface FIG. 28, if needed for ad hoc administrator control. The Site Server 110 verifies that a license key supplied by the Patch Program 200 on the Site Server is valid and not expired. If the license key is not valid or has expired, then the Site Server 110 will not execute the Patch Program 200. The Site Server 110 also verifies and extracts digitally signed files supplied by the Remote Client Server, for example, by verifying AES encrypted MD5 fingerprints. The Site Server checks versions of the software updates and exec updates downloaded from the Master Distribution Server via the Web Reporting Server for the Site Server and Remote Client Servers. The Site Server generates detailed client and Site Matrix reports of which software updates were downloaded, staged, installed, and applied for all the Remote Client Servers on the customer network 102. The Site Server also writes custom Application event logs to report the status and events that can be monitored. The Site Server also automatically cleans up and removes logs, data, hotfixes, software patches and service packs when no longer needed. The Site Server also monitors and executes various programs or “execs” (.exe files), for example, Access.exe. 400, DConfig.exe. 500, VCheck.exe. 600, Report.exe. 700, Stage.exe. 800, Install.exe. 900, Remove.exe 1000, Reboot.exe. 1100, Collect.exe. 1200, Detail.exe. 1300, Matrix.exe. 1400, Maint_C.exe. 1500, Maint_S.exe 1600, Rollup.exe. 1700, and Update.exe 1800. These execs are launched, controlled, and monitored by a site management program or exec 200 called Patch.exe 200 which also executes on the Site Server 110. In the illustrated embodiment, the Patch Program 200 operates as an “agentless” design with the Remote Client Servers, such that no program services or client install agent is required on the Remote Client Servers for the Site Server to begin managing the software updates for the Remote Client Servers.

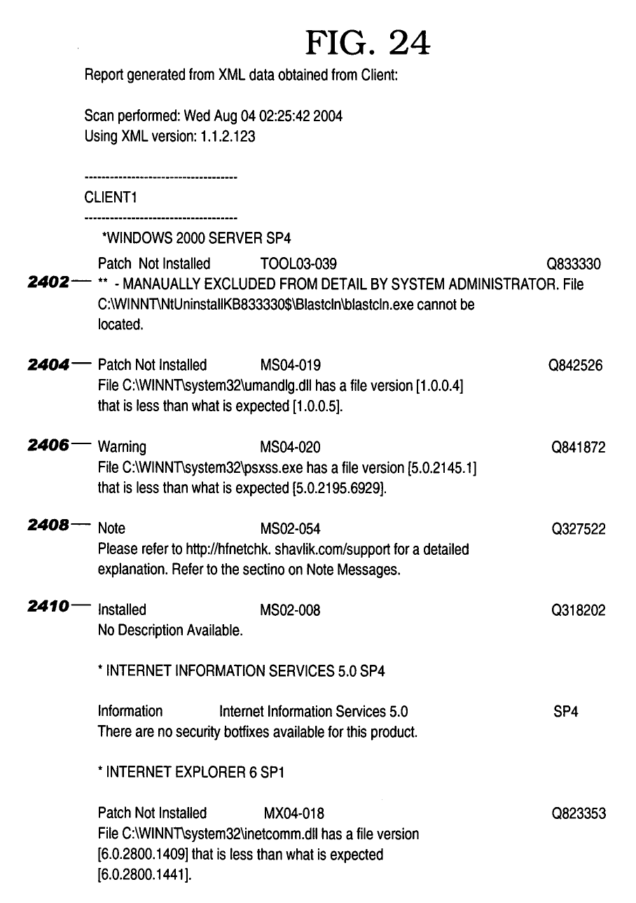

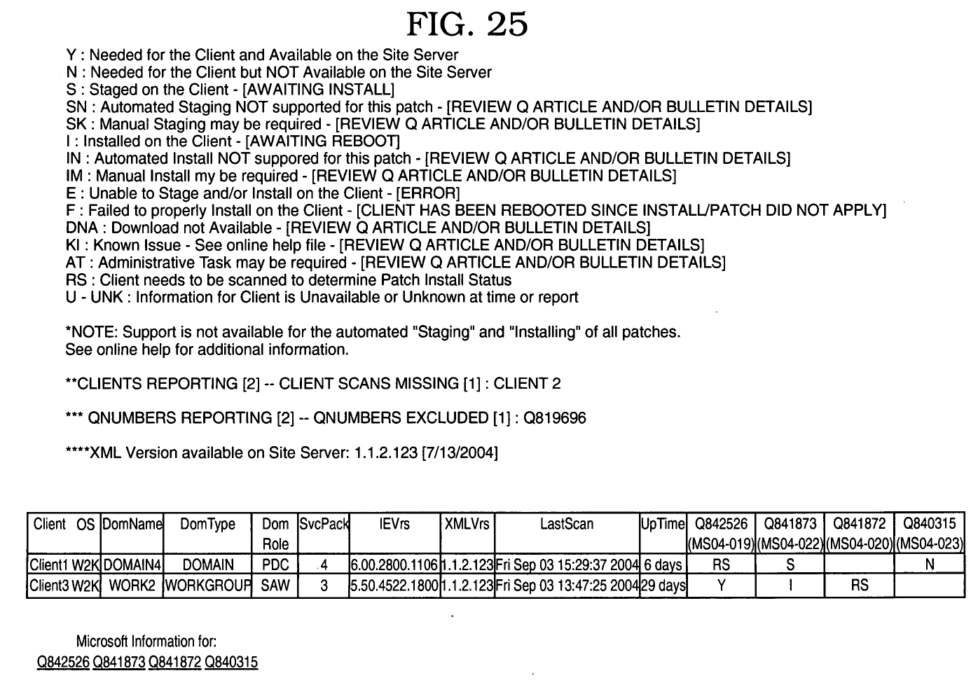

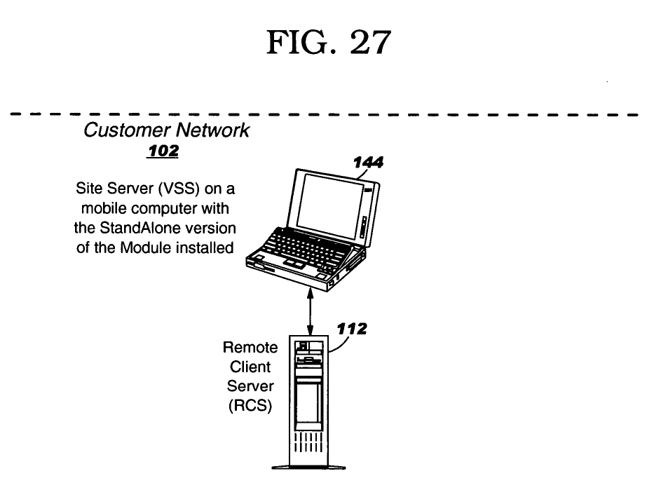

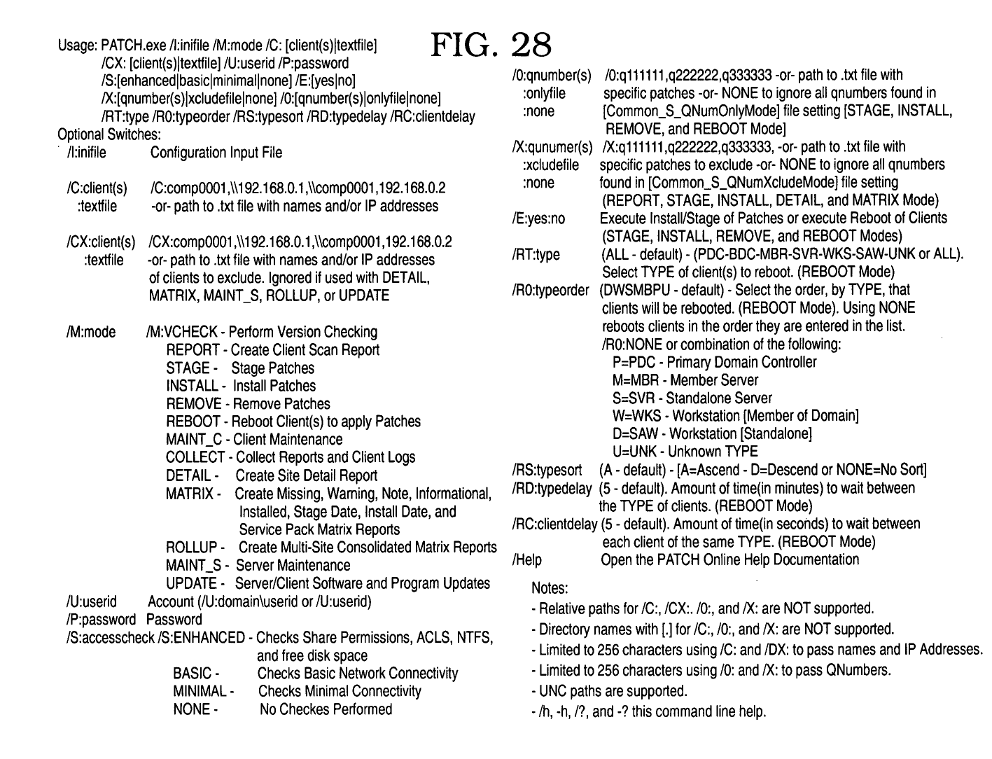

The Access exec (Access.exe) 400 checks that the Remote Client Servers are configured correctly and can be accessed by the Site Server. The Access exec performs four levels of Remote Client Server access checking based on configured threshold and desired level of checking (for example, “enhanced”, “basic”, “minimal” and “none”). The default threshold is to perform the access check every time Patch exec (Patch.exe) 200 is executed but can be changed by a system administrator to be performed any number of hours. The DConfig exec (DConfig.exe) 500 distributes runtime client configuration files to the Remote Client Servers. The DConfig exec is executed if the Report exec (Report.exe), Install exec (Install.exe), or Remove exec (Remove.exe) are executed. Depending on the configuration of the Remote Client Server, the Install exec 900 may also execute on the Remote Client Server. In such a case, the DConfig exec will also distribute the runtime client configuration files. The VCheck exec (VCheck.exe) 600 performs MD5 checks and distributes any required updates to the execs 400-1800 on the Site Server and Remote Client Server if needed. The Report exec (Report.exe) 700 scans the Remote Client Servers to determine the status of needed security hotfixes, software patches, and software service packs. The Report exec (Report.exe) also compresses, encrypts and moves the resulting zip file that contains the .xml data and the Report exec logs to a collection location on the Remote Client Server. The Stage exec (Stage.exe) 800 identifies the security hotfixes, patches and service packs needed for download to and installation on the Remote Client Server. Consequently, only the required subset of security hotfixes, patches and service packs needed by the Remote Client Server are distributed to each Remote Client Server. The Stage exec (Stage.exe) 800 also performs MD5 verification of all needed security hotfixes, software patches, and software service packs needed by the Remote Client Server then stages the verified files to the Remote Client Server. The Install exec (Install.exe) 900 installs all needed security hotfixes and software patches that are identified as needed and successfully staged by the Stage exec. The Install exec is not allowed to automatically install any security hotfixes, software patches or service packs that will disrupt a service or the operating system on the Remote Client Server. This avoids unplanned outages for the customer. Typically, the Remote Client Servers are configured for automatic staging and installation. However, the Stage exec will also stage all needed security hotfixes, patches and service packs to Remote Client Servers which are not certified for automated installation. This still benefits the system administrator in not having to manually obtain security hotfixes, patches and service packs. The Remove (Remove.exe) exec 1000 removes security hotfixes and software patches from Remote Client Servers. The Remove exec is typically used if a security hotfix or software patch has resulted with undesirable impact to the customer environment. The Reboot exec (Reboot.exe) 100 automatically reboots the Remote Client Servers. The Reboot exec can be configured to run concurrently with the Stage exec and Install exec, but is typically scheduled separately by the system administrator to comply with the customer change control processes. The Reboot exec configuration allows for the Remote Client Servers to be grouped by their type or role (i.e. Primary Domain Controller, Backup Domain Controller, Member Server, Stand-alone Server, Domain Workstation, Stand-alone Workstation) such that all Remote Client Servers of the same type or role are rebooted in a controlled order. This ensures availability of any dependency services or critical servers that are needed for other servers within the customer network. The Reboot exec also allows reboots based on system administrator selected software updates identified by respective Qnumber or other identifier. A “Qnumber” is an identifier supplied by Microsoft Corporation for its own software updates, but any identifier for a software update will suffice. Only the Remote Client Servers that are affected by the selected software updates (for example, identified by respective Qnumbers) will be rebooted. By default, the Reboot exec will automatically identify and only reboot Remote Client Servers that are affected by “missing” software updates (for example, identified by respective Qnumbers). The Collect exec (Collect.exe) 1200 collects encrypted reports, data, and logs from the Remote Client Server. The Collect exec also decrypts and extracts the data to be processed by the Detail exec 1300 and Matrix exec 1400. This data obtained by the Collect exec is used by the Site Server to create individual detailed reports as illustrated in FIG. 24 for each Remote Client Server and eight Site Matrix reports FIG. 25 that consolidate the data into a summarized report that provides the data for all clients of the Site. The Detail exec (Detail.exe) 1300 creates individual client reports that represent the client vulnerability compliance status. These reports include missing, warning, note, installed and information status for all security hotfixes and software updates (for example, identified by respective Qnumbers) for the client. If the Detail exec is configured for “verbose”, the report provides a detailed description about the Qnumber. The Detail exec consolidates and compresses the Remote Client Server reports into a zip file to be collected and used by the Web Reporting Server 114. The Matrix exec (Matrix.exe) 1400 uses the data obtained by the Collect exec to create Site based status reports indicating (a) what software updates are needed by each Remote Client Server, (b) warnings of the Remote Client Server vulnerability compliance status, (c) statements that specified software updates have been found and available for download or not found on the respective Site Server, (d) dates that staging and installation of security hotfixes and software patches were performed, and (e) progress of current staging and installations, including problems encountered. The Matrix exec also consolidates and compresses the foregoing reports which are read by the Web Reporting Server using OpenSSH. The Maint_C exec (Maint_C.exe) 1500 maintains and cleans up all client data, reports, and logs on each Remote Client Server based on its specified retention policy. The Maint_S exec (Maint_S.exe) 1600 maintains and cleans up all collected client data, reports, logs, and all consolidated data on the Site Server based on its specified retention policy. The Rollup exec (Rollup.exe) exec 1700 consolidates reports from the Detail exec and Matrix exec from multiple Remote Client Servers to create a single set of reports for all customer sites. The Update exec (Update.exe) 1800 obtains from the Master Distribution Server security hotfixes, software patches, and service packs needed by the Remote Client Server as well as updates to the execs 400-1800 needed by the Site Server. By default, the Update exec is not used by the preferred embodiment illustrated in FIG. 1. The Update exec is used by the alternate embodiment illustrated in FIG. 26. Additionally, the Update exec can be used by the alternate embodiment illustrated in FIG. 27 if authorization has been granted and access to the Master Distribution Server is available from the mobile computer.

A Down program or exec 300, executing on the Master Distribution Server 116, establishes a connection to Internet 108, downloads security hotfixes, patches, and service packs, and provides security for the process. For example, the Down exec generates 256-bit AES encrypted 160-bit MD5 (RFC 1321 compliant application) fingerprints and 2048-bit GnuPG (RFC 2440 compliant application) digital signatures. Master Distribution Server 116 pushes the digitally signed files to Web Reporting Server 114 using OpenSSH. Web Reporting Server 114 verifies the digital signatures and pushes the verified files to Site Server 110 using OpenSSH. Site Server 110 launches Patch program 200 when Site Server receives the software updates or at scheduled periods.

The Patch program 200 on the Site Server 110 verifies the license key supplied by Patch Program 200 on the Site Server by initiating KeyCheck program 2000. The KeyCheck program 2000 obtains the machine name, SID (security identifier), and expiration information from the license key and the Site Server 110. If the Site Server information matches that in the license key, Site Server 110 allows the Patch program 200 to continue. The Patch program begins initializing the configuration on Site Server 110 by initiating an Initialize INI process 212. The Initialize INI process 212 locates the default or custom configuration file. If neither file is located, Initialize INI process 212 locates the template configuration file that supports replaceable parameters to self-configure program 200 and create a default configuration file. The template configuration file is compared to the configuration file to determine if it is newer. If the template configuration is newer, any new settings are automatically updated in the default configuration file and all existing custom configuration files. Program 200 continues on Site Server 110 by initiating a DoServerVersionCheck program process 220. The DoServerVersionCheck process 220 verifies and extracts digitally signed files that have been pushed to the Site Server from the Web Reporting Server and verifies the AES encrypted MD5 fingerprints for them. If the files are authentic, Program 200 initiates a DoModeLaunchMode program process 222 to launch the execs for the Remote Client Servers to install the software updates there. Process 222 is repeated until all selected execs involved in the updates to the Remote Client Servers have been completed. While process 222 executes the execs for the Remote Client Server 112, process 222 continually controls and monitors all execs on Site Server 110. Process 222 launches only the execs for a maximum number of Remote Client Servers 112 that are allowed. Process 222 will terminate execution of execs for any non-responsive Remote Client Servers.

Then, Program 200 executes the Access exec 400 for each Remote Client Server 112. The Access exec 400 checks that the last Remote Client Server access check is older than the access check threshold setting. If the Remote Client Server 112 has not been checked within the threshold value, the Access exec will perform a variety of checks determined by the access check type setting. If the Remote Client Server fails during the access check, it will be excluded from processing by any additional execs.

If the configuration for Program 200 selects the Report exec 700, Install exec 800, or Remove exec 1000, Program 200 executes the Dconfig exec for each Remote Client Server 112. Dconfig exec 500 pushes the runtime generated configuration files that will be needed for the Remote Client Server 112. If the Remote Client Server fails during the DConfig exec, the Remote Client Server will be excluded from processing by any additional execs.

Then, Program 200 executes the Vcheck exec 600 for each Remote Client Server 112. Vcheck exec 600 verifies the encrypted MD5 fingerprints and pushes any required Patch files to the Remote Client Server 112. If the Remote Client Server fails during the Vcheck exec, the Remote Client Server will be excluded from processing by any additional execs.

Then, Program 200 executes the Report exec 700 for each Remote Client Server 112. Report exec 700 determines if the Report exec was executed using the local scan option that is available. If the local scan option is selected, the Report exec executes a hfnetchk.exe exec (or equivalent program) and displays the results to the Remote Client Server 112 console. The vendor of each software program running on the Remote Client Server that is subject to automatic updates with the present invention, reports (in a “cab” or other such update notification file) each new available software update to the Master Distribution Server. Then, the Master Distribution Server pushes the update notification file to the Site Server via the Web Reporting server. The Site server then notifies the hfnetchk.exe exec. The hfnetchk.exe is a command line executable licensed from Shavlik Technologies that scans each Remote Client Server to determine if the Remote Client Server has the new software update. If not, the hfnetchk.exe determines if the Remote Client Server has the previous version of the software program for which the update is suitable. If so, then the hfnetchk.exe creates a report that the Remote Client Server is a candidate for installation of the software update. Then, the Stage, Install, Detail and Matrix execs use this report. If the local scan option is not selected, the Report exec executes the hfnetchk.exe, then compresses and encrypts the results in a zip file for collection by the Collect exec. If the Remote Client Server fails during the Report exec, the Remote Client Server will be excluded from processing by any additional execs.

Then, Program 200 executes the Stage exec 800 for each Remote Client Server 112. The Stage exec 800 gets the list of software update identifiers (such as QNumbers) and service packs that are needed by the Remote Client Server 112. If a Qnumber is needed and it is related to the Internet Explorer product, an Internet Explorer Versions table is checked to verify the version on the Remote Client Server is supported. Otherwise a software “products” table is checked to verify the software version on the Remote Client Server is supported. The software products table is maintained by the owner of the Customer Network 102, and lists software products that can be installed and updated at the Remote Client Servers. If the software product is supported, the files are verified using MD5, and the files are staged to the Remote Client Server. If a simulate option is selected, the Stage exec executes normally except it does not actually stage any software updates for installation in the Remote Client Server. Instead, it simulates the staging of the files to the Remote Client Server and logs the simulated results to the Stage log. The log results are used by a system administrator to determine what will happen without impacting the Remote Client Server. If the Remote Client Server fails during the Stage exec, the Remote Client Server will be excluded from processing by any additional execs. If the simulate option is not selected, and a service pack is needed, the software products table is checked to verify the software product version on the Remote Client Server is supported. If the software product is supported, the files are verified using MD5, and the files are staged to the Remote Client Server.

Then, Program 200 executes the Install exec 900 for each Remote Client Server 112. The Install exec 900 gets the list of QNumbers that are needed by the Remote Client Server 112. If a Qnumber is needed and it is related to the Internet Explorer product, the Internet Explorer Versions table is checked to verify the version on the Remote Client Server is supported. Otherwise the software products table is checked to verify the product version on the Remote Client Server is supported. If the software product is supported, the software update is installed to the Remote Client Server. If the simulate option is selected, the Install exec executes normally except it does not actually perform an install of any software files to the Remote Client Server. The simulate option causes the Install exec to log the simulation information to the Install log, thus allowing the system administrator to see what will happen without impacting the Remote Client Server. If the Remote Client Server fails during the Install exec, the Remote Client Server will be excluded from processing by any additional execs.

Then, Program 200 executes the Remove exec 1000 for each Remote Client Server 112. The Remove exec 1000 gets the list of software updates (identified by Qnumbers of other identifiers) that are found on the Remote Client Server 112. If a software update is selected for removal and found on the Remote Client Server, the software update will be removed. If the simulate option is selected, the Remove exec executes normally except it does not actually remove any software updates from the Remote Client Server. The simulate option causes the Remove exec to log the simulation information to the Removelog, thus allowing the system administrator to see what will happen without impacting the Remote Client Server. If the Remote Client Server fails during the Remove exec, the Remote Client Server will be excluded from processing by any additional execs.

Then, Program 200 executes the Reboot exec 1100 for each Remote Client Server 112. The determination of which Remote Client Servers to reboot and the order is defined when the DoModeLaunch process 222 obtains the settings input by the default ini, custom ini, or command line options FIG. 28. The Reboot exec reboots the Remote Client Server. If the simulate option is used, the Reboot exec executes normally except it does not actually reboot the Remote Client Server. The simulate option causes the Reboot exec to log the simulation information to the Reboot log, thus allowing the system administrator to see what will happen without impacting the Remote Client Server.

Then, Program 200 executes the Collect exec 1200 for each Remote Client Server 112. The Collect exec 1200 gets the list of files found on the Remote Client Server. The files for which the Collect exec checks are the Report log files and the zipped results of the Report exec. The files located on the Remote Client Server are compared to the files stored on the Site Server for the Remote Client Server. If the file is not located on the Site Server 110, the file is collected, then decrypted, and unzipped. If the Remote Client Server fails during the Collect exec, the Remote Client Server will be excluded from processing by any additional execs.

Then, Program 200 executes the Detail exec 1300. Detail exec 1300 gets the list of Remote Client Server directories on Site Server 110 that contain collected Remote Client Server reports. The most recent xml file, indicated by the directories, is opened and parsed for the list of software update identifiers (such as QNumbers). Detail exec 1300 generates and saves the Remote Client Server text report illustrated in FIG. 24. All of the Remote Client Server text reports are zipped and moved to the location for pickup by Web Reporting Server 114.

Then, Program 200 executes the Matrix exec 1400. Matrix exec 1400 gets the list of Remote Client Server directories on Site Server 110 that contain collected Remote Client Server reports. The Remote Client Server status is loaded into an array. Each Matrix type selected is processed. A “matrix” type is a summarized Site based view of the Remote Client Server data. By way of example, there are eight “matrix” types: missing, warning, patch found, service pack, stage date, install date, note, and informational. By default, all matrix types are selected in the configuration. The systems administrator can set the configuration to select one, some, or all. Dynamic column headers are written to csv and html output. Each Remote Client Server array is processed and the body data is written to csv and html output as illustrated in FIG. 25. The footer data is also written. The foregoing is repeated until all matrix types have been processed. All csv, html, and Site specific files are zipped and moved to the location to be picked up by Web Reporting Server 114.

Then, Program 200 executes the Maint_C exec 1500 for maintenance of each Remote Client Server 112. Maint C exec 1500 gets the list of files found for the Remote Client Server. The age of each file is compared to the retention policy configured by Program 200. If the file is older than the defined retention threshold, the Maint_C exec removes the file from the Remote Client Server. Maint_C exec 1500 then checks for any software updates (identified by Qnumber or other identifier) which are staged and present on the Remote Client Server. If the software update has already been installed or is no longer needed, the Maint_C exec deletes the software update files from the Remote Client Server.

Then, Program 200 executes the Maint_S exec 1600 for maintenance of the Site Server. Maint S exec 1600 gets the list of files found on the Site Server 110 that are used for distribution to the Remote Client Server, all Site Server logs and consolidated reports, and all Remote Client Server logs and reports stored on the Site Server. The Maint_S exec compares the age of each such file to the retention threshold configured in Program 200. If the file is older than the defined threshold, the Maint_S exec removes the file from the Site Server 110. Maint_S exec 1600 then checks for any updates (identified by Qnumber or other identifier) that are available for distribution on the Site Server. If the update is no longer needed by any Remote Client Server of the Site, the software update files are deleted from the Site Server 110.

Then, Program 200 executes the Rollup exec 1700. Rollup exec 1700 gets the list of all available Detail zip files found on the Site Server. If there are two or more found, all Remote Client Server text reports illustrated in FIG. 24 are extracted and consolidated into a multi-site Detail zip file. Rollup exec 1700 gets the list of all Matrix zip files found on the Site Server. If there are two or more found, the Rollup exec processes and consolidates all csv files and data into multi-site Matrix csv files and HTML reports as illustrated in FIG. 25.

Then, Program 200 executes the Update exec 1800. Update exec 1800 uses information generated by the Matrix exec to obtain the list of software updates (identified by Qnumber or other identifier) needed by all Remote Client Servers of the Customer Site. Update exec 1800 will download the digitally signed files for the identified software updates from the Master Distribution Server 116 directly to the Site Server 110 for later staging and installation at the Remote Client Servers. The Update exec 1800 also checks for any updates to the execs 200 and 400 - 1800, as explained above, and then downloads the digitally signed files for these exec updates from Master Distribution Server 116 for updating at the Site Server 110.

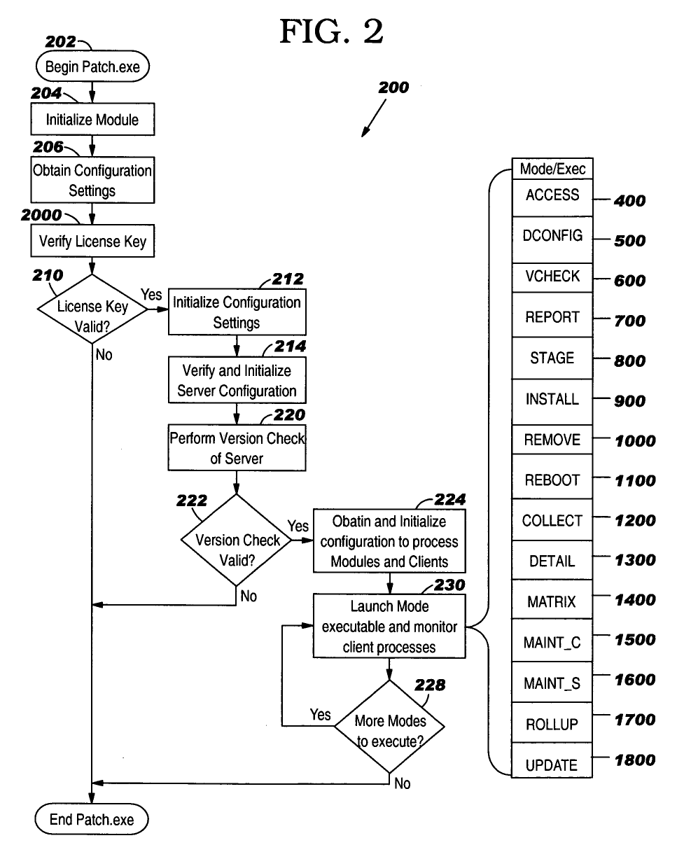

FIG. 2 illustrates in more detail the Patch Program 200 which executes in Site Server 110. Program 200 initializes itself by performing a series of self checks including network connectivity, port access, security, directories, shares, and space requirements (step 204). Then, Program 200 obtains configuration settings for the configurable execs 400-1800 and options (step 206). The configuration settings comprise an extensive choice of parameters to allow the Program 200 to be optimally configured for the Customer Network 102 environment. Then, Program 200 verifies the license key on the Site Server (step 2000). If the license key is valid, then Program 200 initializes the configuration settings, i.e. dynamically processes the default ini or custom ini and any command line options FIG. 28 provided (step 212). Then, Program 200 verifies and initializes the configuration of the Site Server by verifying credentials and that key Site Server resources are available and accessible (step 214). Then, Program 200 checks the version of module and software on the Site Server that has been pushed from the Web Reporting Server 114 (step 220). If the versions match (decision 222, yes branch), then Program 200 obtains and initializes the configuration that will be used for each Remote Client Server in the customer network by using the settings obtained from processing the default of custom ini file, any command line options (illustrated in FIG. 28), and any client exceptions (step 226). Then, the Program 200 launches and executes each of the execs: Access 400, DConfig 500, VCheck 600, Report 700, Stage 800, Install 900, Remove 1000, Reboot 1100, Collect 1200, Detail 1300, Matrix 1400, Maint_C 1500, Maint_S 1600, Rollup 1700, and Update 1800. After each exec is launched Program 200 monitors the progress and results of the execs (step 224 and decision 228).

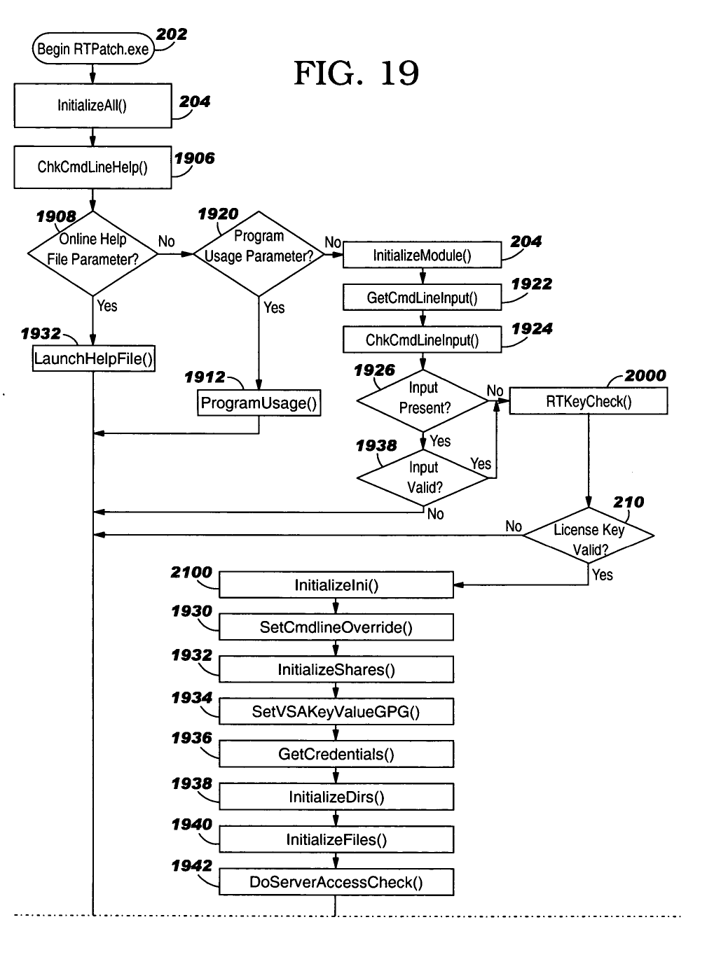

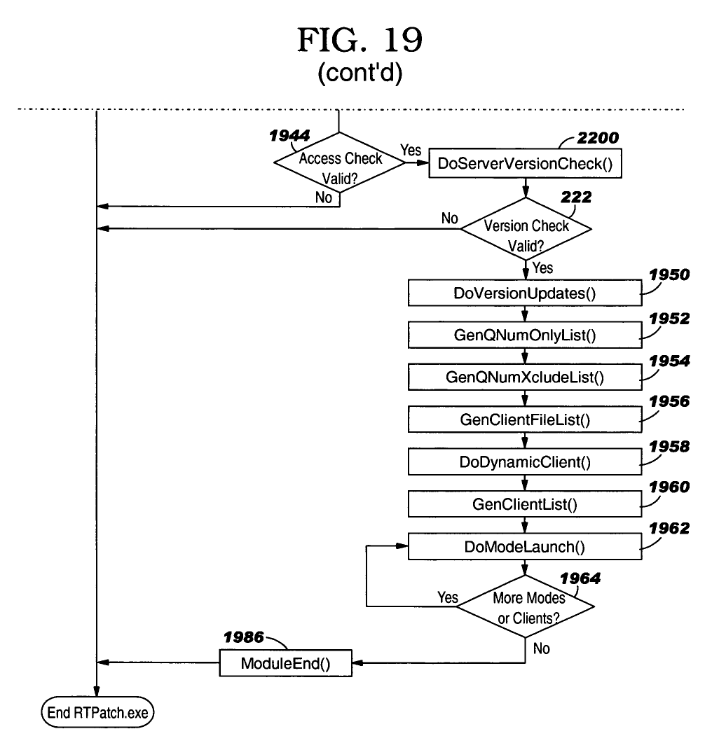

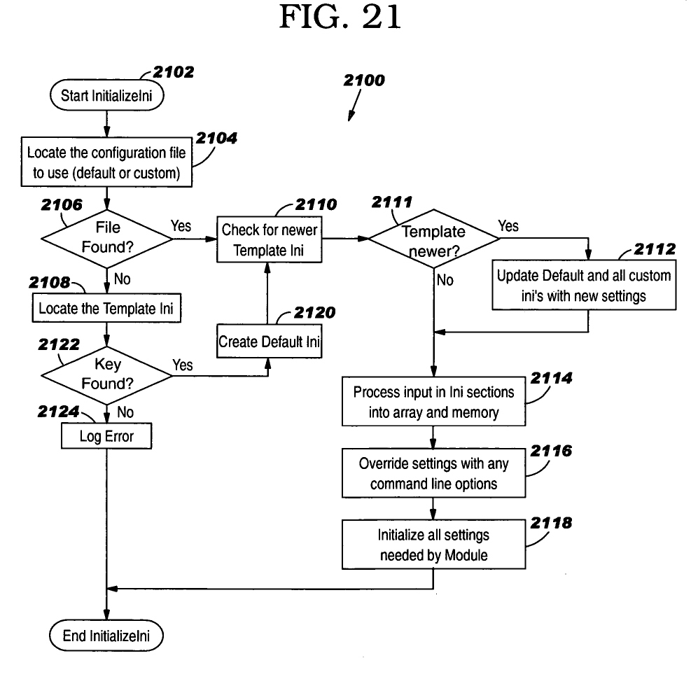

FIG. 19 illustrates in still more detail the steps performed by the site management/Patch Program 200. The Master Distribution Server 116 (in the example shown in FIG. 1, or the combined server 134 in the example shown in FIG. 26, or the stand-alone mobile computer shown in FIG. 27) launches Program 200 (step 202). Then, Program 200 initializes itself by performing a series of self checks including network connectivity, port access, security, directories, shares, and space requirements (step 204). Then, Program 200 checks a command line for a help request by the systems administrator (step 1906). If the systems administrator requests help (decision 1908, yes branch, then the program 200 fetches and launches a help program module (step 1910). However, if the systems administrator has not requested help, then Program 200 determines if there is a specified program usage parameter, for example, /h, -h, /q, -q (decision 1920). If so, then Program 200 displays the command line usage syntax and options FIG. 28 (step 1912). If not, then Program 200 obtains and checks command line input for validity which may indicate option setting or specific Remote Server Clients to execute on (steps 1922 and 1924). If no command line input is present (decision 1926, no branch) or if command line input is present and valid (decision 1938, yes branch), then Program 200 executes the KeyCheck program process (step 2000). The KeyCheck program process ensures that Program 200 is only allowed to continue on a correctly licensed Site Serve. If the license key is expired or invalid, an error is written to an application event log on the Site Server, and Program 200 will exit. In the illustrated embodiment, the license key is secured with AES 256-bit encryption using a hashed pass phrase. If the license key is valid (decision 210, yes branch), then Program 200 proceeds to initialize configuration settings by executing the InitilizeIni process (step 212). The InitializeIni process is illustrated in FIG. 21. The initialization maintains, manages, creates, and obtains configuration settings from one or more INI files that are readable or encrypted for additional security. Traditionally, ini files are static configuration files that are manually maintained by the system administrator. Program 200 dynamically processes the default, custom, and template ini files allowing for automatic updates to all defined ini files when new settings are needed by Program 200, thus avoiding the need for the administrator to manually add or change any ini files. The initialization process allows for usage of replaceable variables within a template INI allowing the template to work in the specific Site Server environment. The template INI allows for the default INI to be automatically configured and created during the initial install. The template INI allows for any new settings to be automatically added to the Program 200 default INI and any other custom INI files that the systems administrator has created. The initialization process allows any updates or upgrades of the Program 200 that require new settings to be implemented transparently without requiring the systems administrator to manually modify any configuration. The initialization process allows the Program 200 to be executed using the command line interface (as illustrated in FIG. 28) to override configuration settings, eliminating the need for the systems administrator to modify the configuration file. After performing the initialization process, Program 200 executes a SetCmdLineOverride program process to set any command line override options specified in FIG. 28 (step 1930). Then, Program 200 initializes shares on the Site Server (step 1932). Then, Program 200 sets a key value GnuPG for the Site Server 110 (step 1934). The key value GnuPG is used by the version checking to verify the digitally signed files. Then, Program 200 obtains “credentials” of the account used when executing Program 200 on the Site Server 110 (step 1936). Then, Program 200 initializes directories for the Site Server (step 1938). Then, Program 200 initializes required configuration and list files for the Site Server (step 1940). Then, Program 200 perform an access self-check on the Site Server 110 (step 1942). If the access self-check is valid, then Program 200 checks the versions of the execs currently installed on the Site Server (step 220). If the version check valid (decision 222, yes branch), then Program 200 performs an update of all available digitally signed files that have been pushed by the Web Reporting Server to the Site Server (step 1950). Then, Program 200 gets the “Qnumber only” lists that can be specified by the system administrator to determine a specific set of Qnumbers to have the Program process for each Remote Client Server (step 1952). Then, Program 200 gets the Qnumber exclude list that can be specified by the system administrator which indicates what set of Qnumbers to exclude from processing (step 1954). Then, Program 200 determines from the selected and configuration input the runtime client configuration file distribution list for each Remote Client Server (step 1956). The Remote Client Server file distribution list indicates which runtime client configuration files are needed for each Remote Client Server. Only the Report, Install, and Remove execs may require runtime configuration files to be distributed to the Remote Client Server. Then, Program 200 creates the Remote Client Server configuration dynamically by using the command line options FIG. 28, ini configuration, Qnumber includes/excludes, and client exceptions specified at runtime (step 1958). Then, Program 200 generates a list of Remote Client Servers (step 1960). Then, Program 200 performs a DoModeLaunch program process to launch the execs on the Site Server 110 (step 222). The DoModeLaunch process executes multiple execs concurrently form multiple Remote Client Servers. The DoModeLaunch process has a configurable wait threshold to determine how long to wait for responses from the Remote Client Servers before concluding that the Remote Client Server is down, while allowing processing for other Remote Client Servers to continue. Program 200 performs the DoModeLauch process for each Remote Client Server (decision 1964). After all execs have completed for all Remote Client Servers, Program 200 summarizes all activity (for example: number of successful clients, number of excluded clients, total Program duration, and individual exec duration) and writes this information to the Program log and the custom application event log (step 1966).

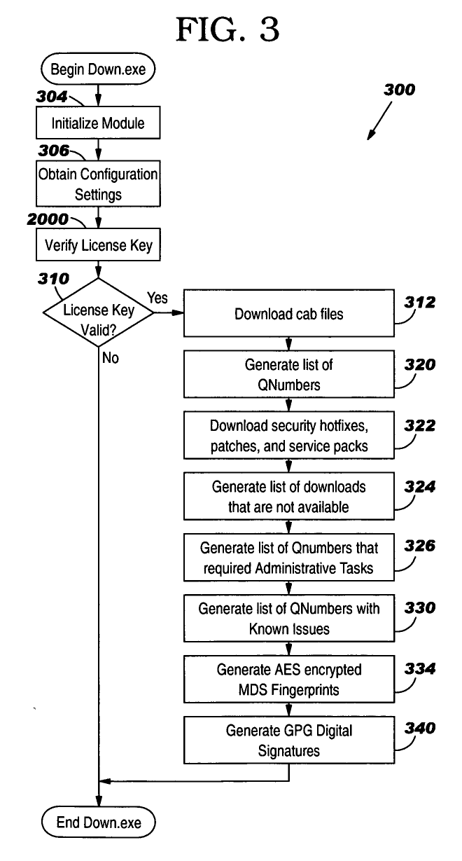

FIG. 3 illustrates in more detail the Master Distribution Program 300 called, for example, Down.exe, which executes in Master Distribution Server 116. Program 300 initializes itself by performing a series of self checks including network connectivity, port access, security, directories, shares, and space requirements (step 304). Then, Program 300 obtains configuration settings from the Program 300 configuration file (step 306). These configuration settings comprise options that determine if required parameters, MD5 fingerprints, and GnuPG signatures will be refreshed for security hotfixes, software patches, and service packs, free space required on the Master Distribution Server, and if service packs and/or patches are to be downloaded. Then, Program 300 verifies a license key supplied with it so it can be executed on the Master Distribution 116 (step 308). If the license key is valid (decision 310, yes branch), then Program 300 downloads from software vendors to the Master Distribution Server 116 cab files (for Microsoft Qnumbered software updates) or other files which specify latest software updates that are available (step 312). Then, Program 300 generates a list of software updates (identified by respective Qnumbers or other identifiers) available and released for download (step 320). Then, Program 300 downloads to the Master Distribution Server the actual, listed security hotfixes, software patches, and service packs which are available from the software vendors via the Internet 108 (step 322). Program 300 also generates a list of software updates that have been created by the software vendor, but not yet available to download from the Internet 108 (step 324). Then, Program 300 generates a list of software updates with known issues (step 330), for example, that prevent automatic installation. For example, certain software updates such as Internet Explorer related hotfixes may require an administrator to login to the Remote Client Server to complete the installation. The list generated by Program 300 will be used later by the Matrix exec and displayed in the matrix reports to all system administrators. Then, in the illustrated embodiment, Program 300 generates AES encrypted MD5 fingerprints for all security hotfixes, patches, service packs, module, and files (step 334). Then, in the illustrated embodiment, Program 300 generates a GnuPG digital signature for the purpose of ensuring authenticity during the transport of files through network infrastructures to the Site Server 110 (step 340).

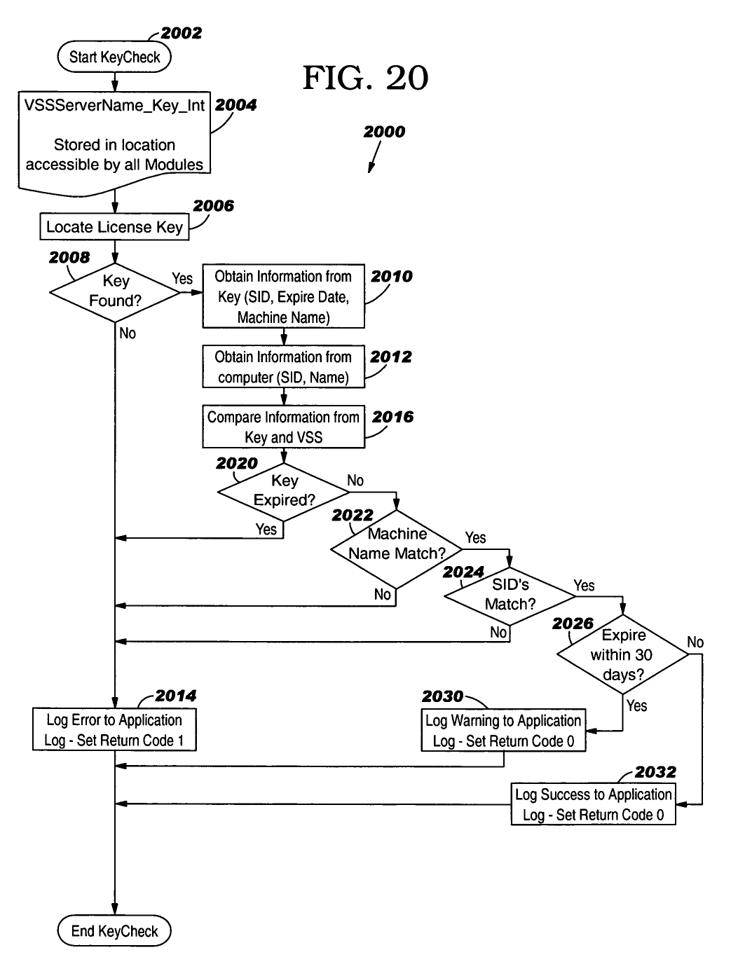

FIG. 20 illustrates the KeyCheck program process 2000 within Site Server 110 in more detail. After startup (step 2002), the KeyCheck program process 2000 obtains the Site Server 110 name and license key from an encrypted license key file (step 2004) stored in Site Server 110 (step 2006). The license key is used to prevent unauthorized use of the Down exec 300 and Patch program 200. By default, in the embodiment illustrated in FIG. 1, license keys can be valid for one year for approved Site Server installations. In alternate embodiments illustrated in FIG. 26 and FIG. 27, license keys are typically valid for thirty to ninety days based on need. If the key is not found (decision 2008, no branch), the KeyCheck process logs an error with a return code of “one”. Assuming the key is found (decision 2008, yes branch), the KeyCheck process 2000 obtains from the key, the SID (security identifier), expiration information and identity of the authorized computer, in this case, Site Server 110. (step 2010). The keycheck program process 2000 then obtains from the Site Server 110, its SID and identity (step 2012), and compares this to the contents of the key 2004 (step 2014). If the key is not expired (decision 2020, no branch), the identity of the Site Server 110 matches the site server identified in the key 2004 (decision 2022, yes branch), and the SID of the Site Server 110 matches the SID in the key 1004 (decision 2024, yes branch ), the KeyCheck process 2000 determines if the expiration date is set to expire within thirty days (decision 2026). If so, the KeyCheck process 2000 logs a warning pertaining to expiration but otherwise logs a return code of “zero” indicating the key is valid (step 2030). If not (decision 2026, no branch), the KeyCheck process logs success with a return code of “zero” (step 2032).

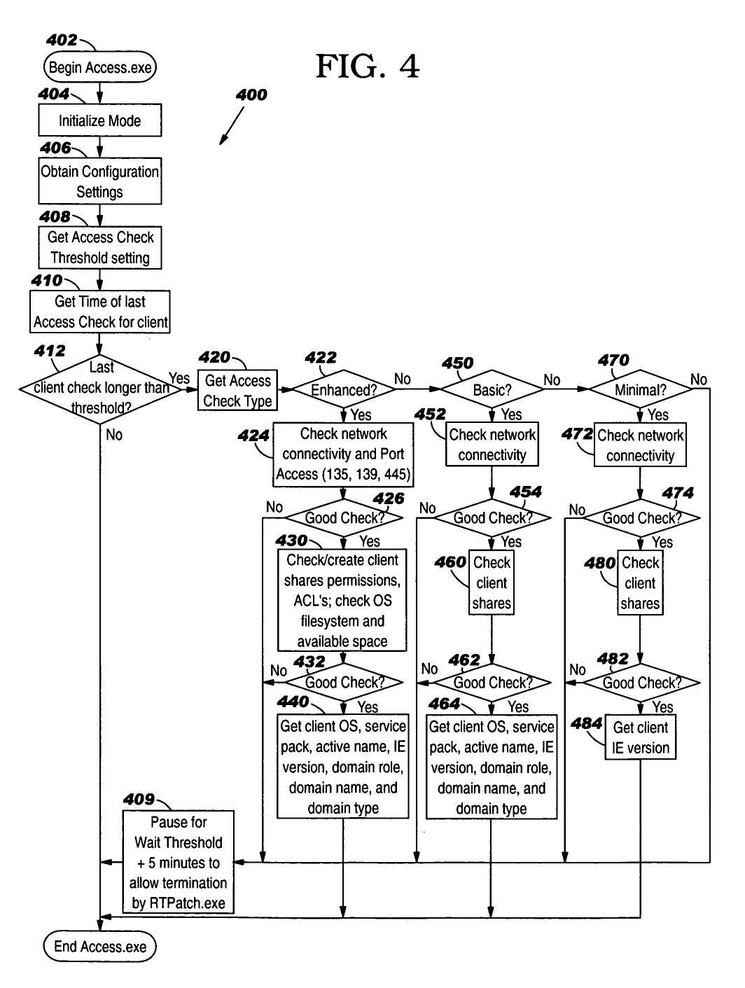

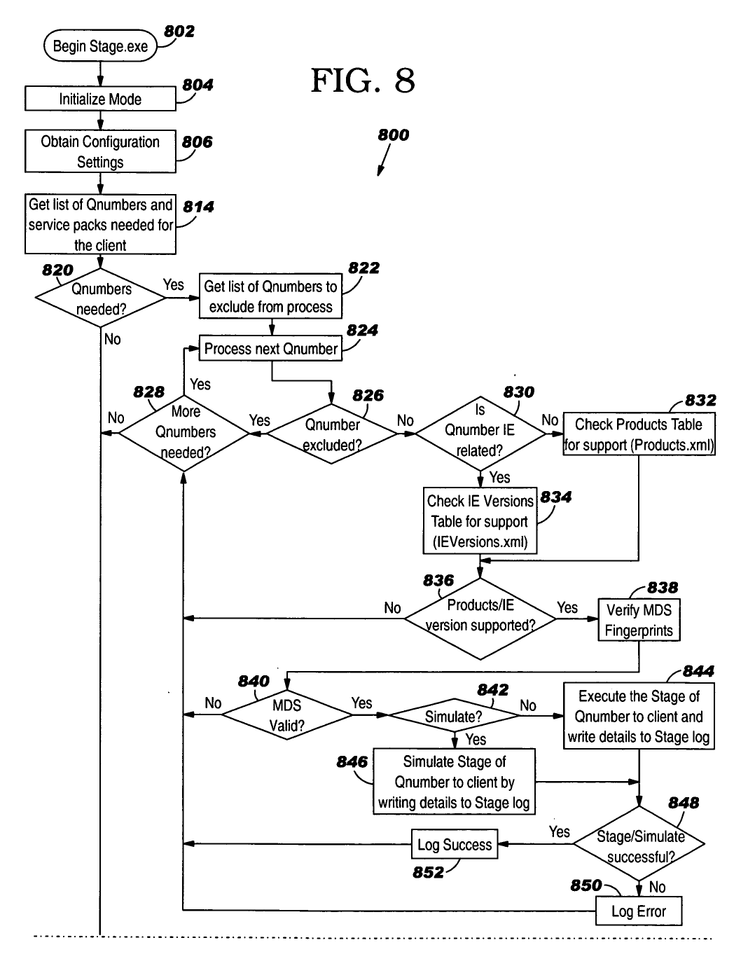

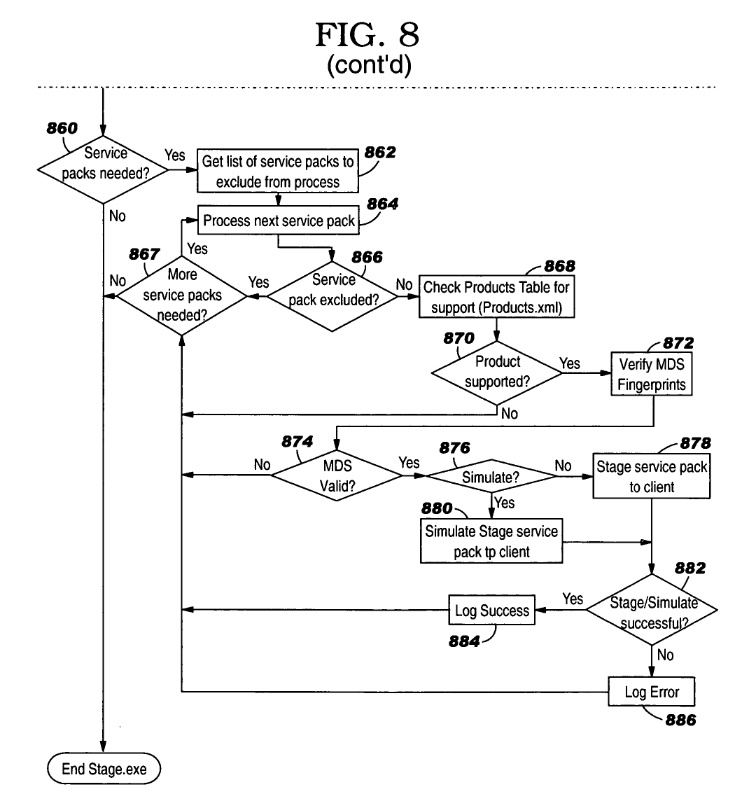

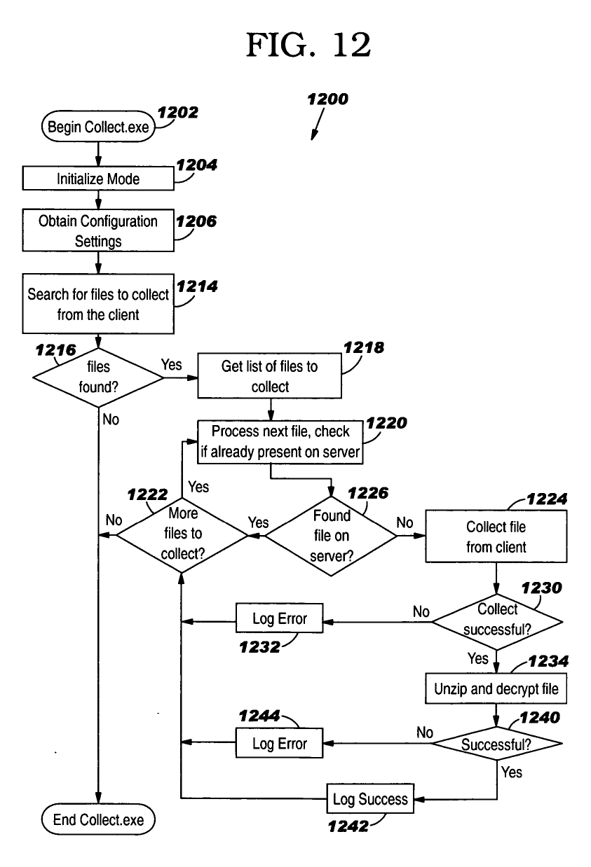

FIGS. 4-18 illustrate in more detail each of the execs 400-1800 launched by the site management/Patch Program 200.

In general, the Access exec 400 ensures that each Remote Client Server is accessible to receive the software updates. The Access exec 400 is executed by the Patch Program 200 for each Remote Client Server. The access type selected by the system administrator allows the Access exec to perform various, corresponding levels of checking of access requirements on the Remote Client Server 112. An Access threshold setting indicates how often the Access exec checks the respective Remote Client Server to verify that connectivity, authorization, and accessibility are current and working. An Access exec for the respective Remote Client Server, will set or create shares or mount points (i.e. hard drive locations or subdirectories on Remote Client Servers, called “mount points” in Unix operating system and “shares” in Microsoft operating system), set permissions for Site Server access, set an access control list, and create directories which are needed. If a Remote Client Server fails an access check, then the Access exec will notify Program 200, and Program 200 will exclude the Remote Client Server from executing any additional execs. FIG. 4 illustrates the Access exec 400 in more detail. In step 402, the site management/Patch Program 200 begins the Access (Access.exe) exec. In response, the Access exec initializes itself by setting the global variables the Access exec will use (step 404). Then, the Access exec obtains client runtime configuration settings that were generated by Program 200 (step 406). Then, the Access exec checks the threshold setting for the selected Remote Client Server (step 408). Then, the Access exec obtains the time of last access check for the selected Remote Client Server (step 410). For the Remote Client Server, if the last access check is older than the threshold (decision 412, yes branch), then the Access exec reads the type of access check for the Remote Client Server (step 420). If the access type is “enhanced”, then the Access exec checks the network connectivity and port access from the Site Server for the Remote Client Server (step 424). If the network connectivity and port access are valid and useful (decision 426, yes branch), then the Access exec checks and/or creates Remote Client server shares (for example, Temp and Reports), permissions, access control lists, type of file system (for example, File Allocation Table, File Allocation Table32, NTFS), and space availability to store software updates (step 430). If all of these are sufficient to allow the software update (decision 432, yes branch), then the Access exec obtains from Remote Client Server the identity of the operating system, operating system service pack, active host name (for example, “COMPUTER17”), Internet Explorer version (for example, “5.00.3105.0106), domain role (for example, Primary Domain Controller), domain name (for example, DOMAIN12), and domain type of Domain or Workgroup (step 440). Referring again to decision 422, no branch, where the access check type is “basic” (decision 450, yes branch), then the Access exec checks network connectivity to the Remote Client Server (step 452). If the network connectivity is sufficient to permit download of the software updates (step 454, yes branch), then the Access exec checks the share of Temp for the Remote Client Server (step 460). If the share is sufficient for network access (decision 462, yes branch), then the Access exec obtains from Remote Client Server the identity of the operating system, operating system service pack, active host name (for example, COMPUTER17), IE version (for example, “5.00.3105.0106”), domain role (for example, Primary Domain Controller), domain name (for example, DOMAIN12), and domain type of Domain or Workgroup (step 464). Referring again to decision 422, no branch and decision 450, no branch, where the access check type is “minimal” (decision 470, yes branch), then the Access exec checks network connectivity to the Remote Client Server (step 472). If the network connectivity is sufficient to permit download of the software updates (decision 474, yes branch), then the Access exec checks the Temp share for the Remote Client Server (step 480). If the share is accessible across the network (decision 482, yes branch), then the Access exec obtains from the Remote Client Server the IE version (for example “5.00.3105.0106”) (step 484). If any of the foregoing tests for any of the access check types fail, then the Access exec notifies the Program 200 which terminates the current Access exec and excludes any additional processing of execs for the Remote Client Server (step 490).

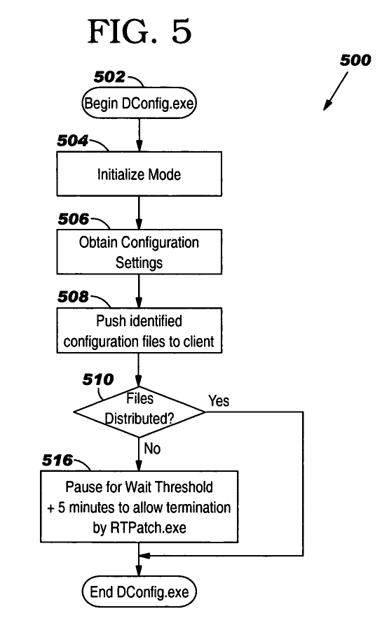

The DConfig exec 500 is only executed if the Report exec, Install exec or Remove exec is selected. The DConfig exec pushes the Remote Client Server runtime configurations files generated by Program 200 to the Remote Client Server. If the systems administrator has specified any software updates (by Qnumber or other identifier) for exclusion or to process a specified set of software updates (by respective Qnumber or other identifier) only, the software identifier list will also be pushed to the Remote Client Server for the Report exec, Install exec, or Remove exec. FIG. 5 illustrates in more detail the DConfig exec 500. In step 502, the site management/Patch Program 200 begins the DConfig exec (DConfig.exe). Then, the DConfig exec initializes itself by setting the global variables the DConfig exec will use (step 504). Then, the DConfig exec 500 obtains configuration settings that were generated by Program 200 (step 506). Then, the DConfig exec 500 pushes the configuration files to the Remote Client Server (step 508). Then, the DConfig exec 500 determines if these configuration files have been successfully distributed (decision 510). If the push was not successful for any Remote Client Server (decision 516, no branch), then the DConfig exec notifies the Program 200 which terminates the current DConfig exec and excludes any additional processing of selected execs for the Remote Client Server (step 516).

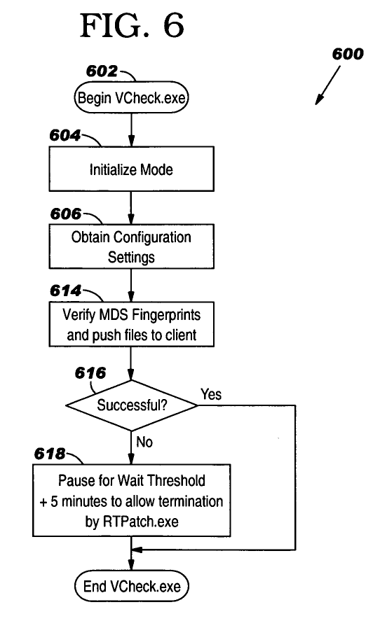

The Vcheck exec 600 verifies AES encrypted MD5 fingerprints of the security hotfixes, patches, service packs, module, and updates downloaded from the Master Distribution Server 116 to the Site Server 110 via the Web Reporting Server 114 for the Remote Client Servers 112. Thus, the Vcheck exec verifies the authenticity, security, and integrity of the software updates on the Site Server before distribution to the Remote Client Servers. The Vcheck exec prevents rogue files (that do not originate from the Management Distribution Server 116) from being injected into or replaced at the Remote Client Servers. FIG. 6 illustrates in more detail the VCheck exec 600. In step 602, the site management/Patch Program 200 begins the VCheck exec (VCheck.exe). Then, the VCheck exec initializes itself by setting the global variables the VCheck exec will use (step 604). Then, the VCheck exec 600 obtains configuration settings that were generated by Program 200 (step 606). Then, the VCheck exec verifies MD5 fingerprints of all security hotfixes, patches, service packs, module, and files, and pushes the verified updates to the Remote Client Servers (step 614). If the push was not successful to any of the Remote Client Server (decision 620, no branch), then the VCheck exec notifies the Program 200 which terminates the current VCheck exec and excludes any additional processing of selected execs for the Remote Client Server (step 618).

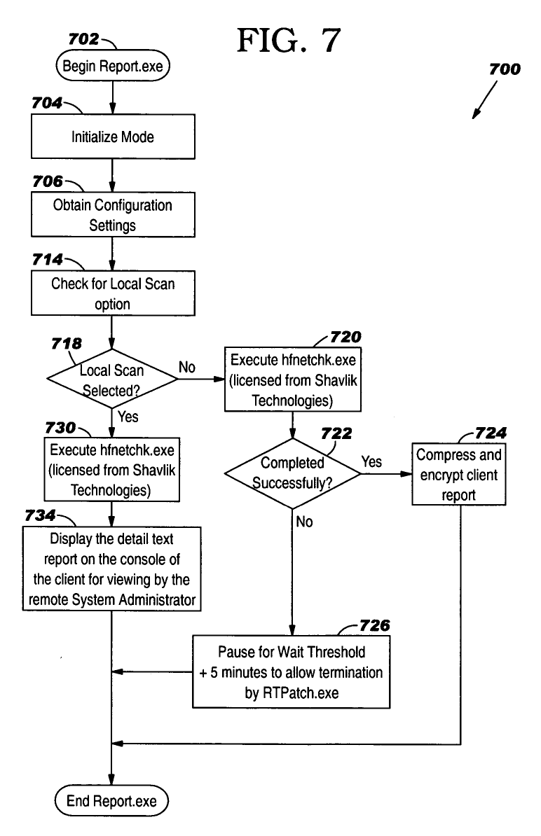

The Report exec 700 scans the Remote Client Server and provides a report of what software updates (identified by respective Qnumbers or other identifiers) are needed. The Report exec supports a local scan option that allows a remote systems administrator to get an immediate status of the Remote Client Server at a console. The report is compressed and encrypted. FIG. 7 illustrates the Report exec in more detail. In step 702, the site management/Patch Program 200 begins the Report (Report.exe) exec. The, the Report exec initializes itself by setting the global variables the exec will use (step 704). Then, the Report exec 600 obtains configuration settings that were generated by Program 200 (step 706). Then, the Report exec checks for the local scan option (step 714). If the local scan option has not been selected (decision 716, no branch), then the Report exec executes a command line program to obtain the list of needed software updates (such as Qnumbers of other identifiers) for the Remote Client Server (step 720). By way of example, the command line program is the hfnetchk.exe exec licensed from Shavlik Technologies. Then, Report exec determines if the hfnetchk.exe exec completed successfully (decision 722). If so, the Report exec compresses and encrypts the report for the Remote Client Server (step 724). If not, the Report exec notifies the Program 200 which terminates the current Report exec and excludes any additional processing of selected execs for the Remote Client Server (step 726). Referring again to decision 716, yes branch where the local scan option was selected, Report exec 700 executes the hfnetchk.exe exec (step 730). Then, the Report exec displays the detailed text report on the monitor of the Remote Client Server for viewing by the remote system administrator (step 734).

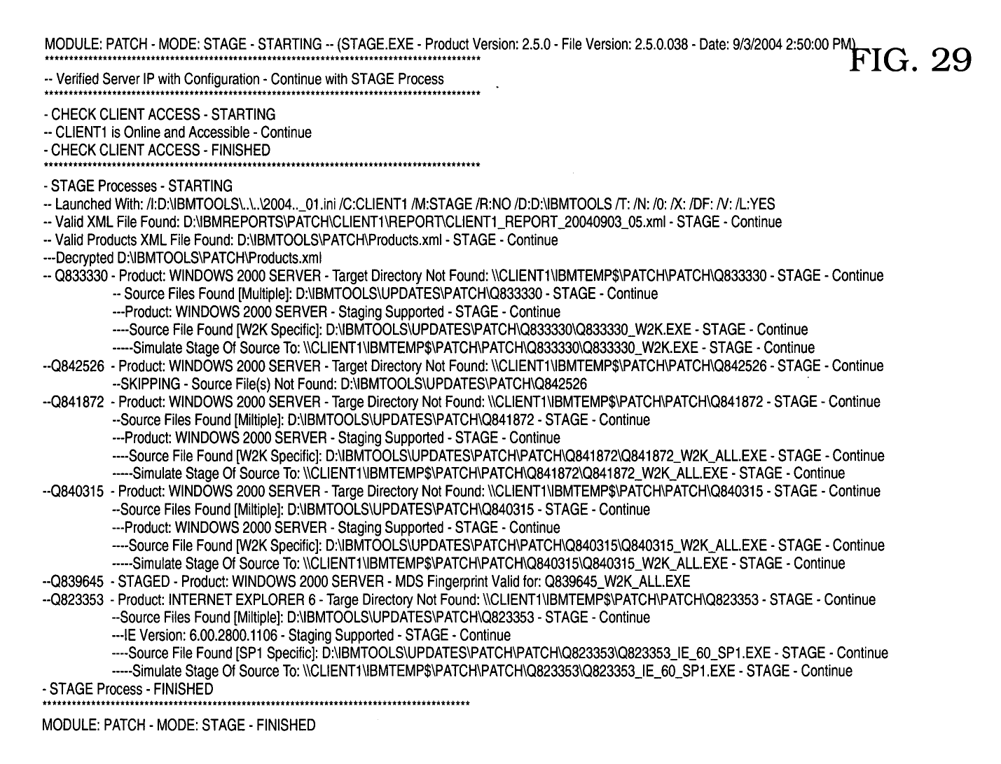

The Stage exec 800 uses the Products.xml file and IEVersions.xml file to determine if a service pack, software product, or IE version is supported for automatic staging. These files are maintained and updated by the developer when a new software product or IE version is released. The Stage exec verifies all security hotfixes, software patches and service packs being staged. The verification comprises verifying AES encrypted MD5 fingerprints of the security hotfixes, patches, and service packs downloaded from the Site Server 110 The simulate option allows the Systems administrator to simulate the staging of software updates (indicated by respective Qnumbers or other identifiers) and preview the log to see what the Stage exec will do before impacting the Remote Client Servers. In step 802, the site management/Patch Program 200 begins the Stage (Stage.exe) exec. Then, the Stage exec initializes itself by setting the global variables the exec will use (step 804). Then, the Stage exec 800 obtains configuration settings that were generated by Program 200 (step 806). Then, the Stage obtains from the Remote Client Server a list of the software updates (specified by respective Qnumbers or other identifiers) needed for the Remote Client Server (step 814). If any software updates are needed (decision 820), then the Stage exec obtains from the Site Server a list of software updates specified by the system administrator (specified by respective Qnumbers or other identifiers) to exclude (step 822). Then, the Stage exec considers the next software update (specified by respective Qnumber or other identifier) obtained in step 814 (step 824). If the Qnumber is in the exclude list (decision 826), then the Stage exec gets the next Qnumber obtained in step 814 (decision 828, yes branch). For each software update identifier (such as Qnumber) which is not in the exclude list (decision 826, no branch), the Stage exec determines if the software identifier is Internet Explorer related, (i.e. checks the product type and if it is Internet Explorer, check the IE version) (decision 830). If not, the Stage exec checks the products table for support, for example, Microsoft SQL Server 7.0 (step 832). If so, the Stage exec checks the IE versions table for support, for example, 5.00.3105.0106 (step 834). After either step 832 or 834, the Stage exec determines if the product/IE version indicated by the software identifier (such as Qnumber) is supported (step 836). If so, the Stage exec verifies the MD5 fingerprint of the software update file(s) (step 838). If the MD5 fingerprint is valid (decision 840), then the Stage exec determines whether the software update staging should be simulated (decision 842). If not, then the Stage exec stages the software update to the Remote Client Server (step 844). If so, then the Stage exec simulates the staging of the software update to the Remote Client Server by the foregoing processing of steps 804-844 and logging the following types of information as illustrated in FIG. 29: (a) the affected product (for example, Internet Explorer, (b) the software product version, (c) whether staging is supported for the software product and version, (d) whether the source files are available on the Site Server for staging to the Remote Client Server, (e) the specific file version of the software update that is applicable to the Remote Client Server, (f) the identities of previously staged updates that are present on the Remote Client Server indicated as “STAGED”, the product name, result of the MD5 check, and the software update file name. The “specific file version of the software update” indicates which available exe version of the update is applicable to the respective Remote Client Server configuration. For the example of software update named “Q123456” with five different execs that are applicable for various configurations of the operating system (for example, Windows NT 4 [NT4], Windows 2000 [W2K], Windows XP [WXP], or Windows 2003 [W2K3]), operating system type (for example, Server, Workstation, Terminal Server, etc.), and service pack (for example, SP1, SP2, SP3, etc.):

Q123456_NT4_S_SP6.exe

Q123456_NT4.exe

Q123456_W2K_ALL_SP4.exe

Q123456_W2K.exe

Q123456.exe

Thus, if the Remote Client Server has Windows NT4 Server SP6 operating system, the Q123456_NT4_S_SP6.exe will be selected for the Remote Client Server and will be indicated in the log as “[SP6 specific]”. A Remote Client Server having Windows 2000 operating system will have Q123456_W2K.exe selected and will be indicated in the log as “[W2K specific]”. Depending on the respective Remote Client Server configuration, the sleeted exe can be Qnumber specific, operating system specific, service pack specific, product major version specific, or product minor version specific (step 846). After either step 844 or 846, the Stage exec determines if the stage simulation was successful (decision 848). If not, then the Stage exec logs an error (step 850). If so, then the Stage exec logs success (step 852). If the simulation option is selected, the Stage log will look similar to that illustrated in FIG. 29, thus allowing the system administrator to preview what will happen to Remote Client Servers without impacting any Remote Client Servers. Referring again to decision 820, no branch where a software update identifier was not needed, the Stage exec determines if the Remote Client Server needs any service packs (decision 860). If so, the Stage exec obtains from the Site Server a list of the service packs to exclude for the Remote Client Server (step 862). Then, the Stage exec considers the next service pack from the list compiled in step 814 (step 864). If the service pack is on the excluded list (decision 866, yes branch), then the Stage exec determines from the list complied in step 814 if there are any more service packs to be considered (decision 868). If so, the Stage exec considers the next service pack on the list in step 864 and determines if it appears on the excluded list (decision 866). For any service pack which is not on the exclude list (decision 866, no branch), then the Stage exec checks the software products table for support (step 868). If the software product is supported (decision 870, yes branch), the Stage exec verifies the MD5 fingerprint of the service pack file(s) (step 872). If the MD5 fingerprint is valid (decision 874), the Stage exec determines whether the software update staging should be simulated (decision 876). If not, the Stage exec stages the service pack for download to the Remote Client Server. If so, the Stage exec simulates the staging of the service pack to the Remote Client Server (step 880). After either step 878 or step 880, the Stage exec determines if the staging or staging simulation of the service pack was successful (decision 882). If so, the Stage exec logs success (step 884). If not, the Stage exec logs an error (step 886).

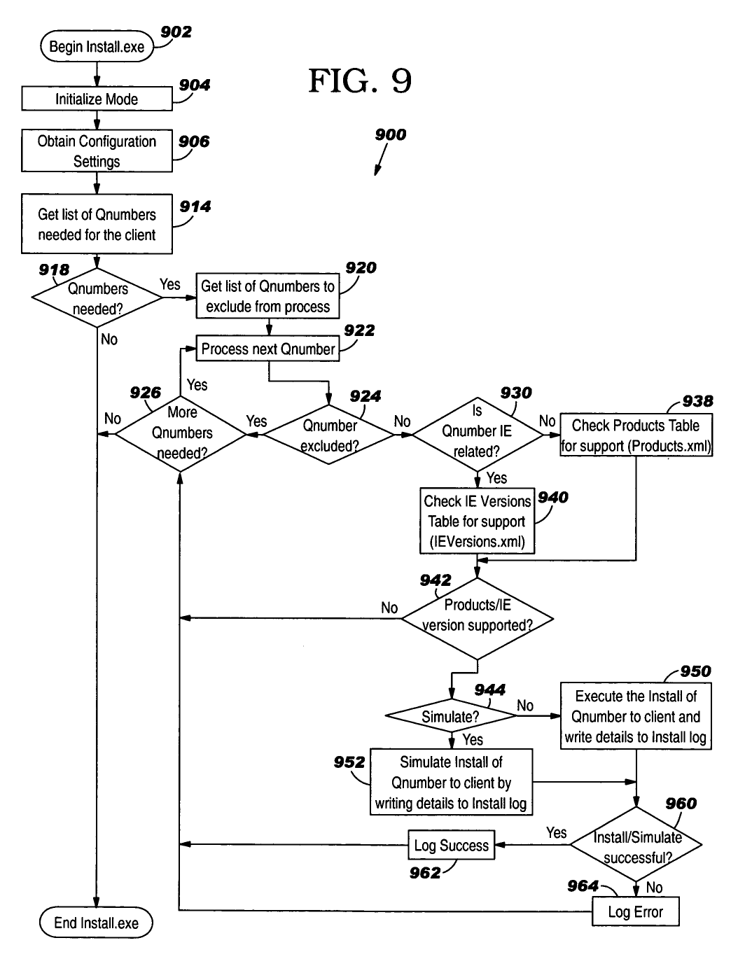

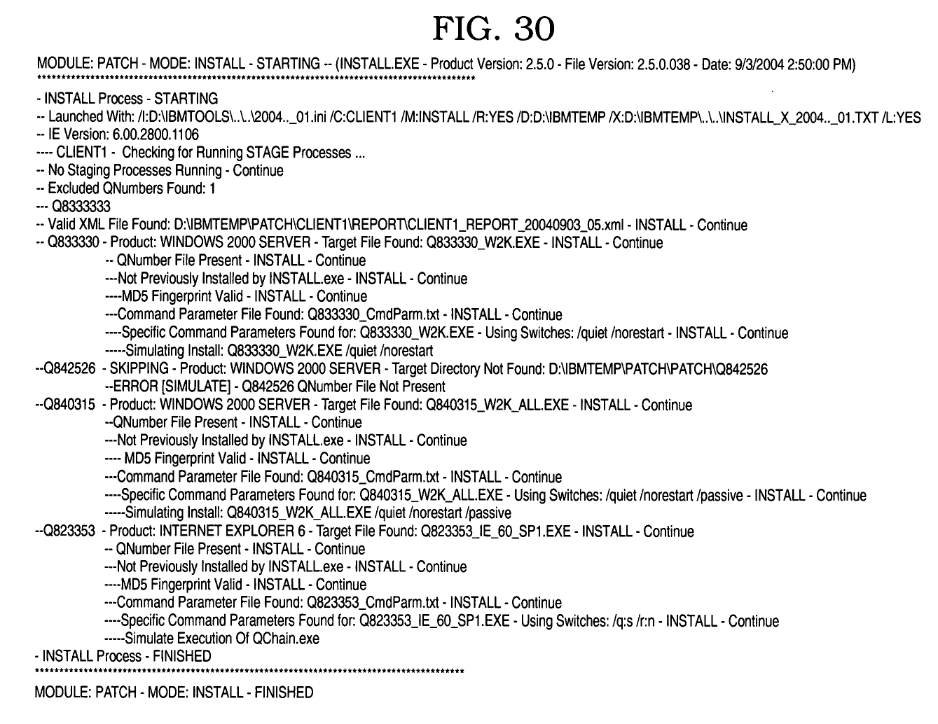

The Install exec 900 uses the Products.xml file and Internet Explorer Versions.xml. file to determine if a software product, or Internet Explorer version is supported for automatic installation. These files are maintained and updated by the developer when a new software product or Internet Explorer version is released. The simulate option allows a systems administrator to simulate an installation and preview the log to see what the Install exec will do before impacting a Remote Client Servers. FIG. 9 illustrates the Install exec in more detail. In step 902, the site management/Patch Program 200 begins the Install exec (Install.exe). Then, the Install exec initializes itself by setting the global variables the Install exec will use (step 904). Then, the Install exec obtains configuration settings that were generated by Program 200 (step 906). Then, the Install exec obtains from the Site Server a list of software updates (identified by respective Qnumbers or other identifiers) needed for each Remote client Server (step 914). If there are any Qnumbers needed by a Remote Client Server (decision 916, yes branch), then the Install exec obtains from the Site Server a list of the excluded Qnumbers (step 920). Then, the Install exec evaluates the first/next software update identifier (such as Qnumber) from the list obtained in step 914 (step 922). If the software update identifier is on the exclude list (decision 924, yes branch), then the Install exec checks if there are any more software identifiers on the list obtained in step 914 (decision 926, yes branch). Then the next software identifier from the list obtained in step 914 is evaluated (step 922). For each software identifier which appears on the list obtained in step 914 and does not appear on the exclude list (decision 924, no branch), the Install exec determines if the software identifier is Internet Explorer related (decision 930). If not, then the Install exec checks the products table for support, for example, MDAC 2.6 for this software identifier (step 938). If so, then the Install exec checks the Internet Explorer versions table for support, for example, 5.00.3105.0106 for this software update (step 940). After either step 938 or step 940, if the software product and/or Internet Explorer version is supported (decision 942, yes branch), the Install exec determines whether to simulate the Installation of the software update (decision 944). If not, then the Install exec proceeds to install the software update to the Remote Client Server (step 950). If so, then the Install exec simulates the installation to the Remote Client Server by the foregoing processing of steps 904-950 and logging the following types of information as illustrated in FIG. 30: (a) the affected product (for example, Internet Explorer version6, (b) whether the software update exe is present on the Remote Client Server, (c) the name of the software update exe, (d) whether the software update has been previously installed (the Install exec has a configurable option to reinstall, although not used by default it is available to the system administrator), (e) the results of the MD5 fingerprint validation, (f) whether the command parameter file is present on the Remote Client Server, (g) whether specific command parameters are found in the command parameter file for the selected software update, (h) the identity of the exact software update command that would be executed including the command parameters to install (step 952). If the simulation option is selected, the Install log will look similar to that illustrated in FIG. 30, thus allowing the system administrator to preview what will happen to Remote Client Servers without impacting any Remote Client Servers. After step 950 or 952, the Install exec logs the result. If the effort was successful (decision 960, yes branch), then the Install exec logs the success (step 962). If not (decision 960, no branch), then the Install exec logs the failure step (964).

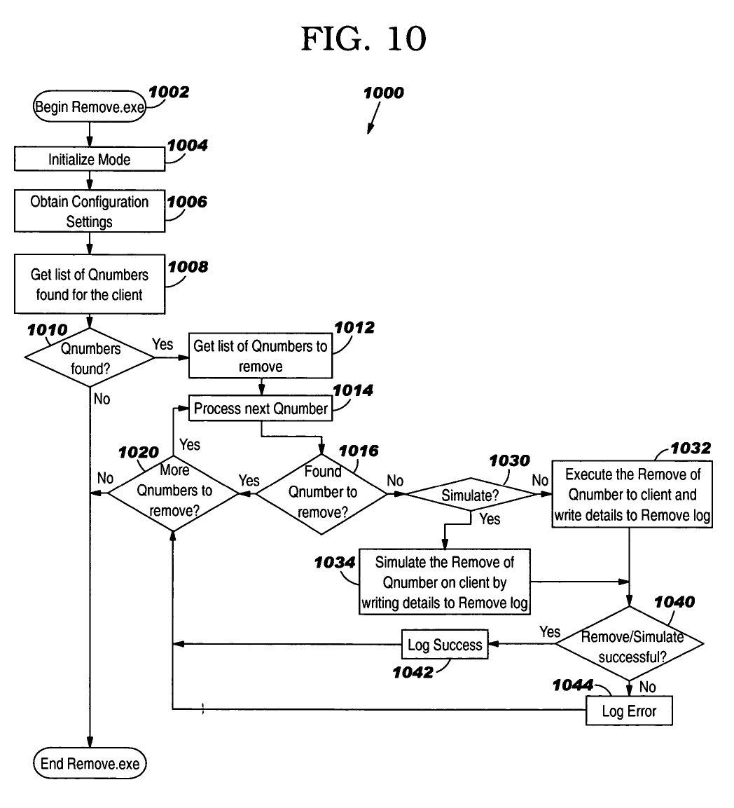

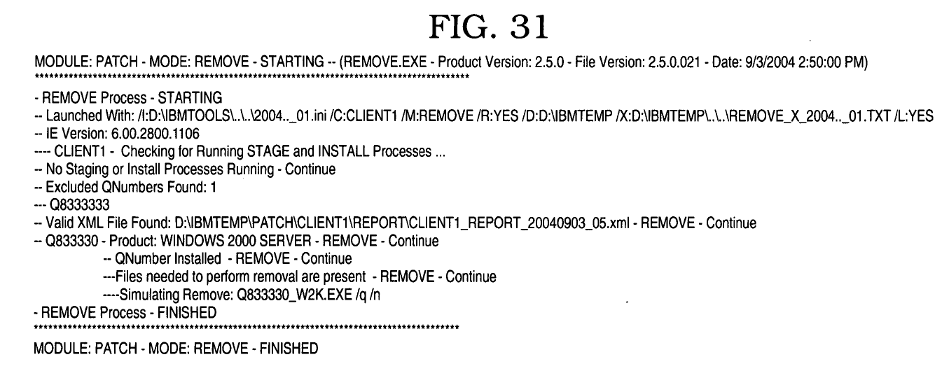

FIG. 10 illustrates the Remove exec 1000 in more detail. In step 1002, the site management/Patch Program 200 begins the Remove exec (Remove.exe). Then, the Remove exec initializes itself by setting the global variables the Remove exec will use (step 1004). Then, the Remove exec obtains configuration settings that were generated by Program 200 (step 1006). Then, the Remove exec obtains from the Site Server a list of the software updates (specified by respective Qnumbers or other identifiers) for each Remote Client Server (step 1008). If any software update identifiers were obtained (decision 1010, yes branch), the Remove exec obtains from the Site Server a list of software update identifiers to remove (step 1012). Then, the Remove exec processes the next software update identifier in the list obtained in step 1008 (step 1014). The Remove exec determines if the software update identifier is in the remove list (decision 1016). If not, the Remove exec determines if there are any more software update identifiers in the list obtained in step 1008 (decision 1020). If so, the Remove exec processes the next software update identifier in the list obtained in step 1008 (step 1014). Referring again to decision 1016, yes branch, for each software update identifier in the list obtained in step 1008 that is listed for removal, the Remove exec determines if the simulate option has been selected (decision 1030). The simulate option allows the systems administrator to simulate a removal of a software update and preview the log to see what the Remove exec will do before impacting the Remote Client Server. If the systems administrator has not selected the simulate option, then the Remove exec removes the software update from the Remote Client Server (step 1032). However, if the systems administrator has selected the simulate option, the Remove exec simulates the removal of the software update on the Remote Client Server by the foregoing processing of steps 1004-1032 and logging the following types of information as illustrated in FIG. 31: (a) the affected product (for example, Internet Explorer version6, (b) whether the software update is installed, (c) whether the software update files needed to perform the removal are present on the Remote Client Server, (d) the identity of the exact software update command that would be executed including the command parameters to remove the software update (step 1034). If the simulation option is selected the Remove log will look similar to that in FIG. 31, thus allowing the system administrator to preview what will happen to Remote Client Servers without impacting any Remote Client Servers. After step 1032 or step 1034, the Remove exec determines if the simulation or removal was successful (decision 1040), and then reports the result, either success (step 1042) or failure (step 1044).

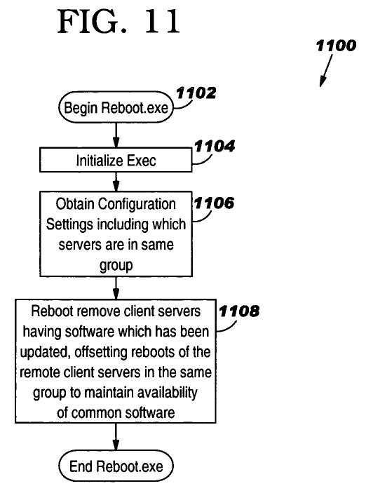

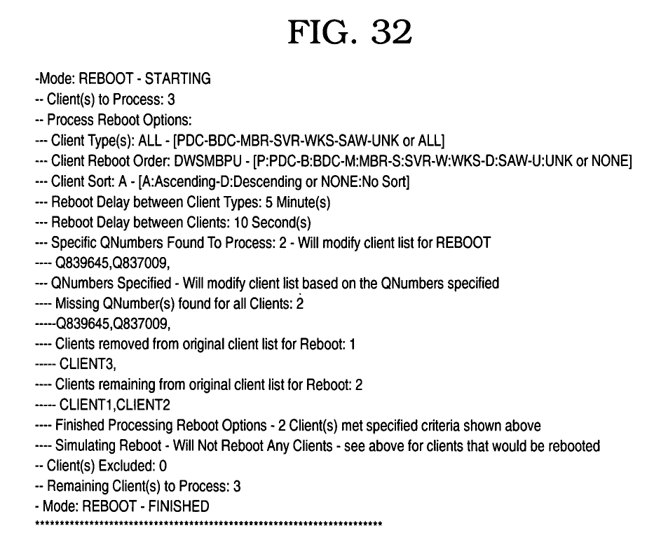

FIG. 11 illustrates the Reboot exec 1100 in more detail. Program 200 performs automatic mass reboots that are controlled, staggered and able to target only the Remote Server Clients that are affected by the software updates. When the Reboot exec is selected but before the Reboot exec is launched, the DoModeLaunch program process 2300 obtains the following additional configuration information (step 2312): (a) type(s) of Remote Client Server, (b) type order, (c) type sort, (d) type delay, (e) Remote Client Server delay, (f) by default that only Remote Client Servers that receive a software update are rebooted, or by systems administrator configuration, a specification of certain software update identifiers and a preference that only the Remote Client Servers that are updated with the identified software are rebooted, (g) software identifier(s) to exclude, (h) by systems administrator configuration, an identification of a subset of Remote Client Servers that have received software updates and a preference that only these Remote Client Servers will be rebooted, (i) clients to exclude. “Type” indicates the type of Remote Client Server (for example, PDC, MBR, etc.). “Type Order” indicates the desired grouping order of the types of Remote Client Servers. “Type Sort” indicates the order of rebooting the Remote Client Servers with the group type (ascending, descending). “Type Delay” indicates the amount of time to wait (in minutes) between the group types. “Remote Client Server Delay” indicates the amount of time to wait (in seconds) between each Remote Client Server within a group type. The DoModeLaunch determines which clients are affected by the selected software identifier(s) and what type of role each Remote Client Server holds on the network. (for example, PDC [Primary Domain Controller also known as PDC emulator for Windows 2000 and 2003 operating systems], BDC [Backup Domain Controller also known as Domain Controller for Windows 2000 and 2003 operating system], MBR [Member Server of a Domain], SVR [Standalone Server not a member of a Domain], WKS [Workstation that is a member of a Domain], SAW [Standalone Workstation not a member of a Domain]. The DoModeLaunch exec takes the configuration information, the Remote Client Server(s) affected by the software identifier(s) information, and the Remote Client Server information, and then formulates a list of Remote Client Servers that are grouped by the type of Remote Client Server. Then, the DoModeLaunch exec puts the groups in the specified order, and removes from the groups any clients that are specifically excluded or are not impacted by the selected software identifier(s). The resulting Remote Client Server order is further controlled by a configured reboot delay between each Remote Client within a group type and a separate delay between the different group types. The delay between reboots of the Remote Client Servers in each critical group ensures that at least one Remote Client Server in each critical group is active at all times, i.e. not being rebooted, to ensure availability of common software/application or services provided by the Remote Client Servers of the group. This is important when the Remote Client Servers in the group provide the same service, and at least one of the Remote Client Servers in the group is needed to provide an important service. Although the default settings are usually sufficient, the system administrator can modify the settings for optimization within the respective customer environment. For example:
Patch.exe/m:REBOOT/rt:PDC,MBR/ro:MP/rs:A/rd:15/rc:10/cx:CLIENT2/o:s5002
   The above command takes the original list of Remote Client Servers of the Site Server, remove all types except Primary Domain Controllers [PDC] and Member Servers [MBR], remove CLIENT2, remove any Remote Client Servers that are not affected by software identifier s5002. The remaining Remote Client Servers will be grouped by MBR's then PDC's, within each group they will be put into ascending order by name. Then DoModeLaunch will wait ten seconds between each MBR Remote Client Server to launch the Reboot exec. After all MBR's are launched, the DoModeLaunch exec will wait fifteen minutes before beginning the group of PDC's. DoModeLaunch will wait ten seconds between each PDC Remote Client Server to launch the Reboot exec. As noted above, Remote Client Servers which provide critical functions and services to customers and other servers are not all rebooted concurrently. The Reboot exec has stored information which indicates minimum allowed time between reboots of individual Remote Client Servers in the same group or subsets of Remote Client Servers in the same group to ensure that they are not all rebooting (and unavailable) at the same time. Even if the systems administrator attempts to enter configuration information that would cause all the Remote Client Servers in the same group to reboot concurrently or in an overlapped manner, in the illustrated embodiment, the Reboot exec will override or not accept this configuration information to ensure that this does not occur. Thus, the Remote Client Servers are rebooted one at a time or in subsets so that one or more of these servers remains operative at all times to perform important functions for the customers and other servers that may require their services. Although not required, a systems administrator can modify the following configuration settings to optimize the Reboot behavior for the respective customer environment: type (/rt:), type order (/ro:), type sort (/rs:), type delay (/rd:), Remote Client Server delay (/rc:). The DoModeLaunch process determines the order of rebooting and the offset or time between reboots of servers in each group based in part on the above configuration settings and also the Remote Client Server types and software identifier(s). Then, the DoModeLauch program process furnishes this list, the order and the offsets to the Reboot exec. In step 1102, the site management/Patch Program 200 begins the Reboot (Reboot.exe) exec. Then, the Reboot exec initializes itself by setting the global variables the exec will use (step 1104). Then, the Reboot exec obtains configuration settings that were generated by Program 200 (step 1106). Then, the Reboot exec reboots each Remote Client Server in the order specified by the DoModeLaunch process (step 1108). Although not shown in FIG. 11, if the systems administrator selects the simulate option, the DoModeLaunch process simulates the rebooting of the Remote Client Servers. If the simulation option is selected the Reboot section of the Program 200 log will look similar to FIG. 32, thus allowing the system administrator to preview what will happen to Remote Client Servers without impacting any Remote Client Servers.

The Collect exec 1200 will find and copy all compressed and encrypted Program 200 data and logs on the Remote Client Server 112 to the Site Server 110. Once the data is transferred to the Site Server, the Collect exec will decrypt and extract the logs and data on the Site Server for later processing by the Detail exec and the Matrix exec. In step 1202, the site management/Patch Program 200 begins the Collect (Collect.exe) exec. Then, the Collect exec initializes itself by setting the global variables the exec will use (step 1204). Then, the Collect exec obtains configuration settings that were generated by Program 200 (step 1206). Then, the Collect exec searches the Remote Client Server for files to collect, decrypt, and extract to the Site Server (step 1214). If any such files are found (decision 1216, yes branch), then the Collect exec obtains a list of the files found to Collect (step 1218). Then, the Collect exec processes each such file. For example, PATCH_REPORT_YYYYMMDD_##.zip is a compressed and encrypted zip file that contains the Remote Client Server data obtained by the Report exec. Then, the Collect exec checks the next file found and determines if the file found on the Remote Client Server has already been collected and processed by the Site Server (step 1220). If the file is found on the Site Server (decision 1226, yes branch), then the Collect exec determines if there are any more files on the list obtained in step 1218 (decision 1222, yes branch). If so, then the Collect exec processes the next file in the list (step 1220). For each file on the list which is not found on the Site Server (decision 1220, no branch), the Collect exec collects the file from the Remote Client Server (step 1224). If the collection was unsuccessful (decision 1230, no branch), then the Collect exec logs an error (step 1232). However, if the collection was successful (decision 1230, yes branch), then the Collect exec unzips and decrypts the file (step 1234). If the unzipping and decryption was successful (decision 1240, yes branch), then the Collect exec logs the success (step 1242). If not, the Collect exec logs the failure (step 1244).

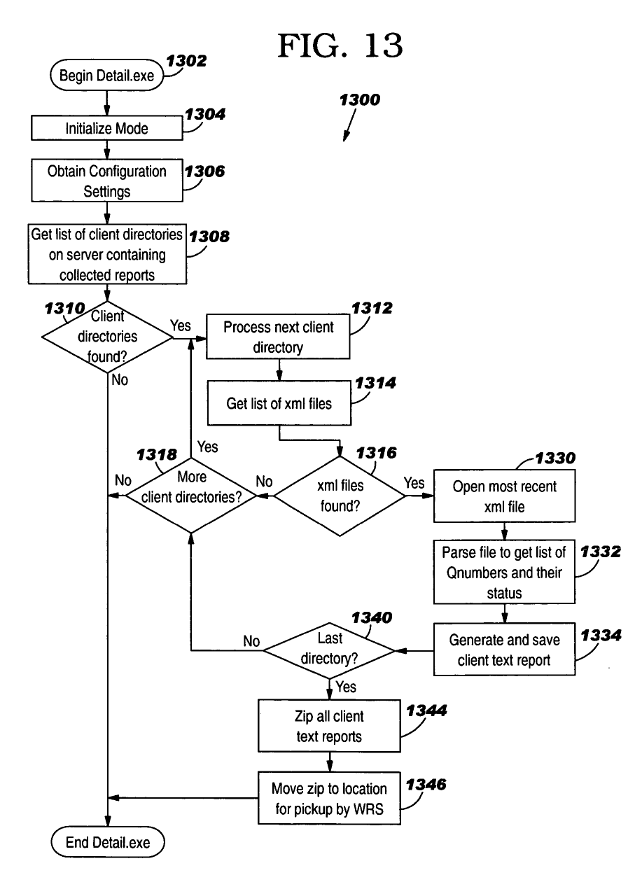

The Detail exec 1300 uses the xml files that the Collect exec collects, decrypts, and extracts to the Site Server from the Remote Client Servers to generate a detailed text report FIG. 24 of the status of the Remote Client Servers in complying with security vulnerabilities. The Detail exec consolidates the detailed text reports into a zip file that is read by the Web Reporting Server using OpenSSH. The systems administrator can specify certain software updates (identified by respective Qnumbers or other identifiers), which are not considered critical or needed for the respective customer network, these will be annotated with “**—MANUALLY EXCLUDED FROM DETAIL BY SYSTEM ADMINISTRATOR” 2402 for the respective software update identifier. Therefore, if there is a software update that the system administrator has determined that no action is required for the respective customer network, this notation will also advise other personnel not to be concerned with the software update with this notation. FIG. 13 illustrates the Detail exec in more detail. In step 1302, the site management/Patch Program 200 begins the Detail exec (Detail.exe). Then, the Detail exec initializes itself by setting the global variables the Detail exec will use (step 1304). Then, the Detail exec obtains configuration settings that were generated by Program 200 (step 1306). Then, the Detail exec obtains from the Site Server a list of directories for Remote Client Servers on the Site Server 110 that contain the collected reports and data (step 1308). If such a directory is found (decision 1310, yes branch), then the Detail exec processes the directory (step 1312). Then, the Detail exec obtains from the Remote Client Server directory the list of xml files present (step 1314). If no such xml files are found (decision 1316, no branch), the Detail exec determines if there are any more Remote Client Server directories in the list obtained in step 1308 (decision 1318). If so, then the Detail exec loops back to step 1312 to process the next Remote Client Server directory in the list, and then to step 1314 to get a list of xml files present for the respective Remote Client Server. If xml files are present (decision 1316, yes branch), the Detail exec opens the most recent xml file (step 1330). Then, the Detail exec parses the xml file to obtain the list of software updates and their status (for example, missing, warning, note, patch found, etc.) (step 1332). Then, the Detail exec generates and saves a text report reflecting these Qnumbers and their status for the Remote Client Server (step 1334). If this is not the last directory in the list obtained in step 1308 (decision 1340, no branch), then the Detail exec loops back to decision 1318 to repeat the foregoing process for the next directory. However, when the last directory in the list has been so processed (decision 1340, yes branch), then the Detail exec zips all the text reports for the Remote Client Servers (step 1344), and then moves the zip file to the location on the Site Server to be read by the Web Reporting Server using OpenSSH (step 1346).

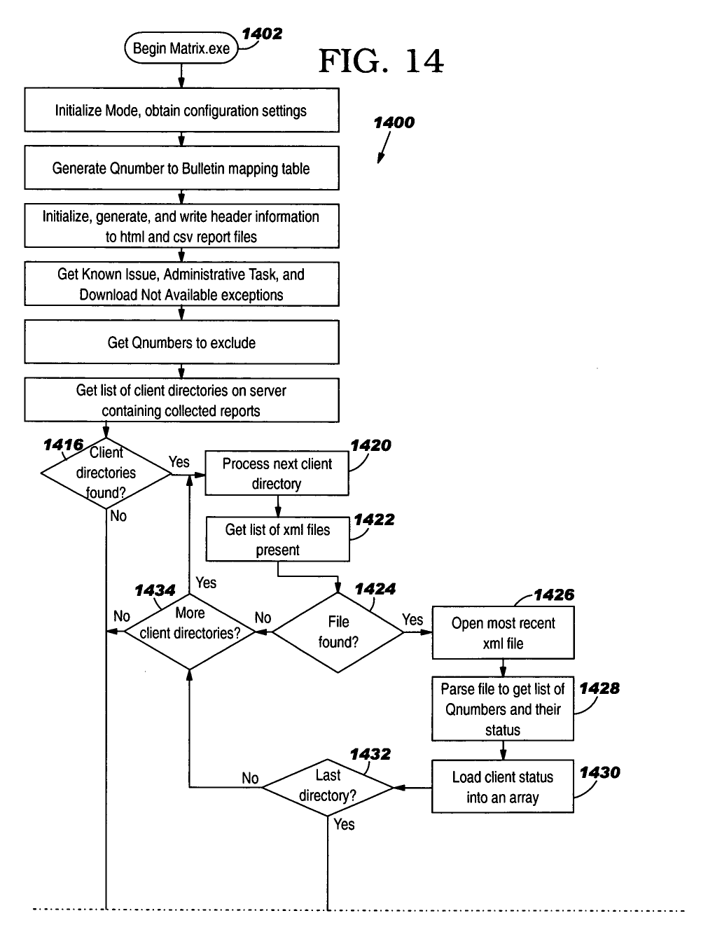

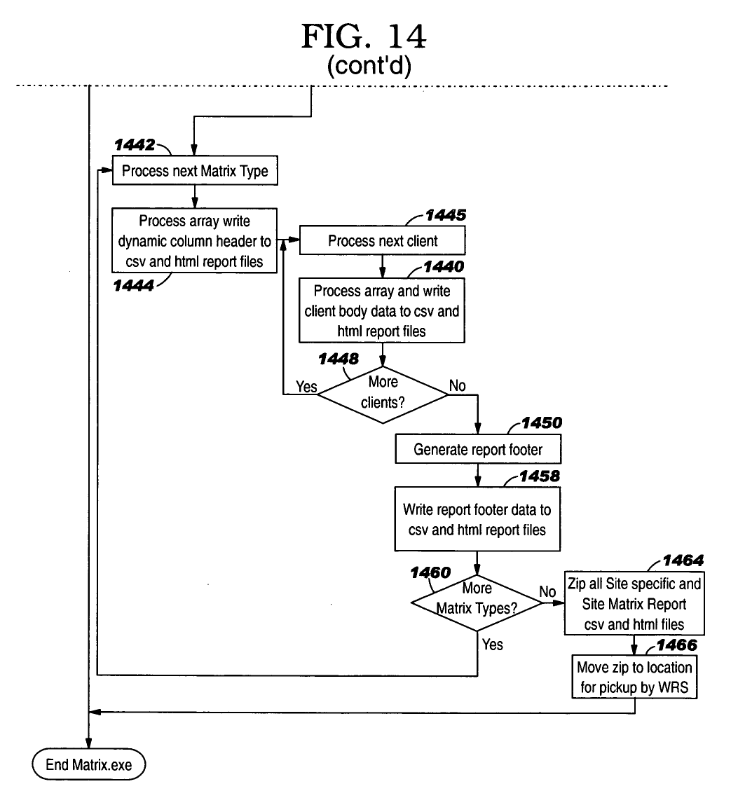

The Matrix exec 1400 generates consolidated summary reports for all Remote Client Servers of the Site Server. By way of example, the Matrix exec creates the consolidated report in CSV format to allow export to other applications and/or databases. The Matrix exec also creates HTML code for the report to allow it to be displayed using a web browser. In the illustrated example, the Matrix exec generates eight different matrix “type” reports, for example, “Missing”, “Warning”, “Note”, “Patch Found”, “Stage Date”, “Install Date”, “Service Pack”, and “Informational”. These reports summarize the status of all Remote Client Servers as to their status within the “type” of matrix, all staging activity allowed by the system administrators for the Remote Client Servers, all install activity allowed by the system administrators for the Remote Client Servers, all exclusions and exceptions, and all known errors. This allows for a comprehensive assessment of the entire Customer Site for all Remote Client Servers at the Site in a matrix “type” view. The Matrix exec uses xml files that the Collect exec collects, decrypts, and extracts to the Site Server from the Remote Client Servers to obtain the status of each Remote Client Server. The Matrix exec obtains from the Remote Client Servers additional information (for example, type of operating system, service pack, domain name, domain role, domain type, Internet Explorer version, and up time) about each Remote Client Server and the status of the Stage exec and Install exec activities. The Matrix exec limits the reports to only those software updates that affect the Remote Client Servers at the Customer Site. The Matrix exec also creates Site specific software update information, for example, SITESERVER_PATCH_MATRIX_QNumbers_Found_YYYYMMDD_##.txt which lists all software updates that are needed for the Remote Client Servers 112 of the respective Site Server 110. The Web Reporting Server 114 will use this information after it reads and extracts the file from the consolidated zip file created by the Matrix exec. The Web Reporting Server will use the information in this file to determine the subset of updates that need to be pushed to the respective Site Server. The Maint_S exec and Update exec will also use this information on the Site Server in the preferred and alternate embodiments to distribute and maintain only the required subset of security hotfixes, software patches and service packs that the Remote Client Servers of the Customer Site need. FIG. 14 illustrates the Matrix exec in more detail. In step 1402, the site management/Patch Program 200 begins the Matrix exec (Matrix.exe). Then, the Matrix exec initializes itself by setting the global variables the Matrix exec will use and obtains configuration settings that were generated by Program 200 (step 1404). Then, the Matrix exec generates a Bulletin mapping table which correlates software update identifiers to the corresponding Security Bulletin (step 1406). A “Security Bulletin” is an identity supplied by Microsoft Corporation for its own security vulnerability releases. Each “Security Bulletin” may have one or more “Qnumbers” associated with it. Then, the Matrix exec initializes, generates and writes header information to html and csv report files (step 1408). The header information comprises the column headings for Remote Client Server information (for example, operating system, domain name, Internet Explorer version, uptime, etc.) and n number of columns for the software update identifier(s) and security bulletin headings FIG. 25 that are generated dynamically based on the associated software update identifiers for the Remote Client Servers of the Site Server. Then, the Matrix exec creates a list of known issues (step 1410). Also, in step 1410, the Matrix exec creates a list of software updates that require administrative tasks. For example, some Internet Explorer related updates require an administrator to login after the install and reboot. Also, in step 1410, the Matrix exec identifies the list of software update downloads which are identified as needed by the Remote Client Servers of the Site Server but not yet downloaded and available for distribution on the Site Server (step 1410). Then, the Matrix exec obtains the list of software updates to indicate as “excluded”, if specified by the system administrator, from the report (step 1412). Then, the Matrix exec obtains from the Site Server a list of directories for Remote Client Servers on the Site Server 110 that contain the collected reports and data (step 1414). If such a directory is found (decision 1416, yes branch) then the Matrix exec processes the directory (step 1420). Then, the Matrix exec obtains from the Remote Client Server directory the list of xml files present (step 1422). If no such xml files were found (decision 1424, no branch), then the Matrix exec determines if there are any more Remote Client Server directories in the list obtained in step 1414. If so, the Matrix exec loops back to steps 1420 and 1422. For any such xml files found (decision 1424, yes branch), the Matrix exec opens the most recent xml file (step 1426). Then, the Matrix exec parses the file to get a list software updates for respective Remote Client Server and their status (step 1428). Then, the Matrix exec loads the status of the Remote Client Server and all identified software update identifiers into an array for later consolidated processing by the Matrix exec (step 1430). If this is the not the last directory (decision 1432, no branch), then the Matrix exec loops back to decision 1434 to process the next directory. However, if this is the last directory (decision 1432, yes branch), then the Matrix exec processes the Matrix type, (for example, missing, warning, etc.) (step 1442). Then, the Matrix exec processes the array and writes the dynamic column header information to CSV and HTML files (step 1444). The “dynamic column headers” indicate that the format and structure for the output of each matrix type is dynamically determined based on the associated software update identifiers for the Remote Client Servers of the Site Servers, for example, yesterday the missing matrix showed ten columns of “missing” Qnumbers. Last night two of the Qnumbers were successfully staged and installed for all Remote Client Servers needing the Qnumber. Today when the “missing” matrix report is created it will only have eight columns of “missing” as the other two Qnumbers are not missing for any Remote Client Servers of the Site. Then, the Matrix exec processes the directory for the next Remote Client Server (step 1445). Then, the Matrix exec processes the array for the individual client information and writes client body data to the CSV and HTML report files (step 1446). The “writes client body data” indicates the individual information for the client such as operating system, Internet Explorer version, etc. and the software update status for the Remote Client Server for each respective software update associated with the “type” of Matrix including any staging or installing activities and any known issues or exceptions. If there are any more Remote Client Servers, the Matrix exec loops back to step 1445 to process the next one (decision 1448, yes branch). After all the directories for all the Remote Client Servers have been so processed (decision 1448, no branch), then the Matrix exec generates a report footer which provides links to the corresponding software updates on the Internet 108 that can be useful if the Site Server has access to the Internet through the customer network (step 1450). Then, the Matrix exec writes the report footer to the CSV and HTML report files (step 1458). Then, the Matrix exec determines if there are any more matrix types to process (decision 1460). If so, the Matrix exec loops back to step 1442 to process the next matrix type. If not, the Matrix exec zips all the Site specific and Site Matrix CSV and HTML report files (step 1464), and then moves the resulting zipped file to the location on the Site Server to be read by the Web Reporting Server using OpenSSH (step 1466).

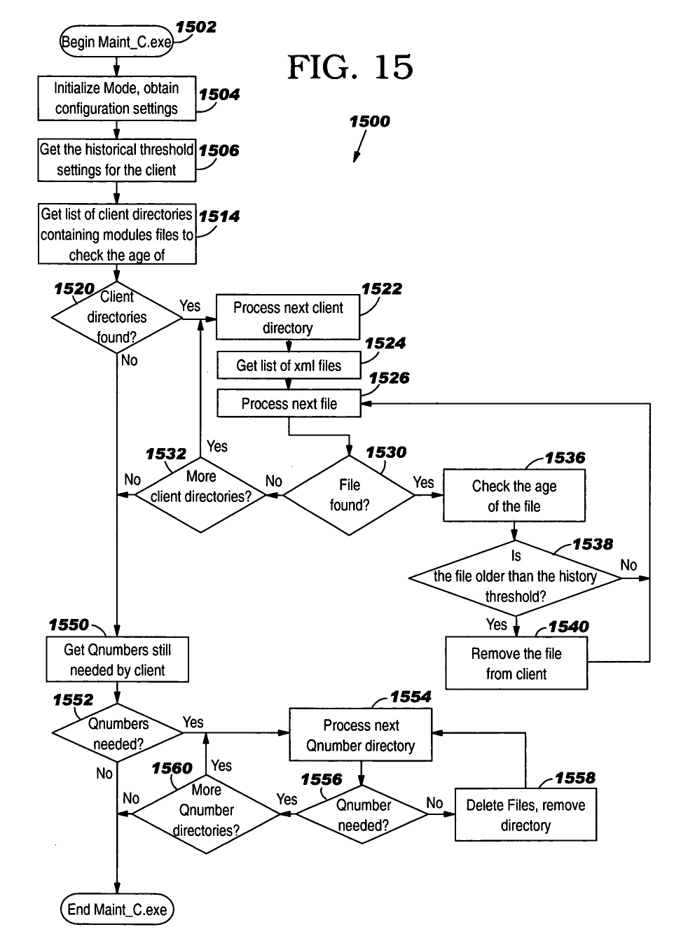

Typically, each Customer Network will have an established data retention policy that all Remote Client Servers must comply. The Maint_C exec 1500 allows the systems administrator to configure the Maint_C exec to discard old report and log files as required to comply with data retention polices for the Remote Client Servers at the Customer Site. Also, when each Remote Client Server no longer needs security hotfixes or software patches that have already been successfully installed or are no longer needed by the Remote Client Server, the Maint_C exec will remove the unneeded or aged files. FIG. 15 illustrates the Maint_C exec in more detail. In step 1502, the site management/Patch Program 200 begins the Maint_C exec (Maint_C.exe). Then, the Maint_C exec initializes itself by setting the global variables the Maint_C exec will use and obtains configuration settings that were generated by Program 200 (step 1504). Then, the Maint_C exec obtains from the Site Server configuration information indicating how long each report or log file should be retained on the Remote Client Server (step 1506). Then, the Maint_C exec obtains from the Remote Client server a list of Remote Client Server directories containing reports and logs for which to check the age (step 1514). If there are any such directories on the list (decision 1520, yes branch), then the Maint_C exec processes the directories, for example, the REPORT or LOG directory (step 1522). Then, the Maint_C exec obtains from the directory a list of the reports and log files (step 1524). Then, the Maint_C exec processes the next report or log file on the list (step 1526). If no such file exists for this directory (decision 1530, no branch), then the Maint_C exec checks if there are any other Remote Client Server directories on the list obtained in step 1514 (decision 1532). If so, the Maint_C exec loops back to step 1522 to process the next Remote Client Server directory and then to steps 1524 and 1526 as described above. For each report or log file for each directory (decision 1530, yes branch), the Maint_C exec checks the age of the file (step 1536). If this file is older than the retention threshold (decision 1538, yes branch), then the Maint_C exec removes the report of log file from the Remote Client Server (step 1540). Referring again to decision 1532, no branch, where there are no more report or log files to process, the Maint_C exec gets the software update identifier (such as Qnumber) of security hotfixes and software patches that are still needed by the Remote Client Server awaiting staging or install (step 1550). If there are any such software identifiers (decision 1552, yes branch), then the Maint_C exec processes the Remote Client Server to determine the software identifier directories and files present (step 1554). Then, the Maint_C exec determines if the software identifier is currently needed by the Remote Client Server (decision 1556). If not, then the Maint_C exec deletes the software file(s) and removes the directory from the Remote Client Server (step 1558). However, if the software identifier is currently needed (decision 1556, yes branch), then the Maint_C exec does not remove any file(s) or directory from the Remote Client Server and determines if there are any more software update identifiers in the list compiled in step 1550 (step 1560). If so, the Maint_C exec loops back to step 1554 to perform the foregoing process for the next software update on the list.

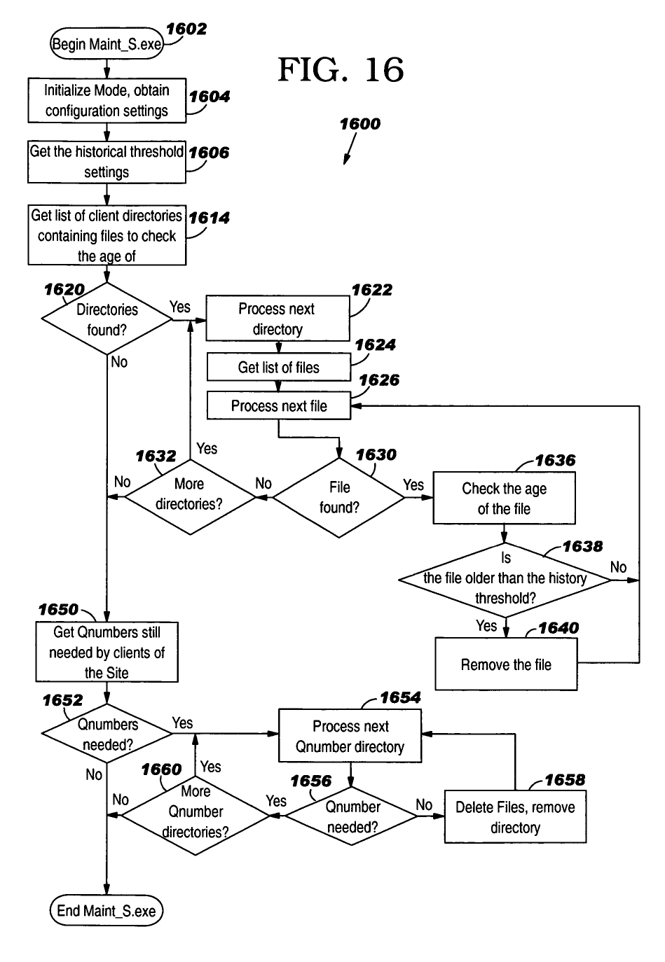

Typically, each Customer Network Site will have an established data retention policy that all computers on the network must comply, this includes the Site Server. The Maint_S exec 1600 allows the systems administrator to configure the Maint_S exec to discard old consolidated data, reports, and log files as required to comply with data retention polices for the Site Server. Also, when all Remote Client Servers no longer need a security hotfix or software patch, the Maint_S exec will remove the unneeded or aged file(s). FIG. 16 illustrates the Maint_S exec in more detail. In step 1602, the site management/Patch Program 200 begins the Maint_S exec (Maint S.exe). Then, the Maint_S exec initializes itself by setting the global variables the Maint S exec will use and obtains configuration settings that were generated by Program 200 (step 1604). Then, the Maint_S exec obtains from the Site Server configuration information indicating how long each report or log file should be retained on the Site Server (step 1606). Then, the Maint_S exec obtains from the Site Server the list of directories containing reports and logs for which to check the age (step 1616). If there are any such directories on the list (decision 1620, yes branch), then the Maint_S exec processes the directory (step 1622). Then, the Maint_S exec obtains from the directory the list of files present (step 1624). Then, the Maint_S processes the next file on the list (step 1626). If no such file exists for this directory (decision 1630, no branch), then the Maint_S exec checks if there are any other directories on the list obtained in step 1614 (decision 1632). If so, the Maint_S exec loops back to step 1622 to process the next directory and then to steps 1624 and 1626 as described above. For each file for each directory (decision 1630, yes branch), the Maint_S exec checks the age of the file (step 1636). If this file is older than the retention threshold (decision 1638, yes branch), then the Maint_S exec removes the file from the Site Server (step 1640). Referring again to decision 1632, no branch, where there are no more files to process, the Maint_S exec gets the software update identifiers of security hotfixes that are still needed by at least one Remote Client Server awaiting staging or installation but not yet installed at the Remote Client Server (step 1650). If there are any such software updates (decision 1652, yes branch), then the Maint_S exec processes the Site Server to determine the software update directories and files present (step 1664). Then, the Maint_S exec determines if the software update is currently needed by any Remote Client Servers (decision 1656). If not, then the Maint_S exec deletes the file(s) and removes the directory from the Site Server (step 1658). However, if the software update is currently needed, by even one Remote Client Server, (decision 1656, yes branch), then the Maint_S exec does not remove any file(s) or directory from the Site Server and determines if there are any more software updates in the list compiled in step 1650 (step 1660). If so, the Maint_S exec loops back to step 1664 to perform the foregoing process for the next software update on the list.

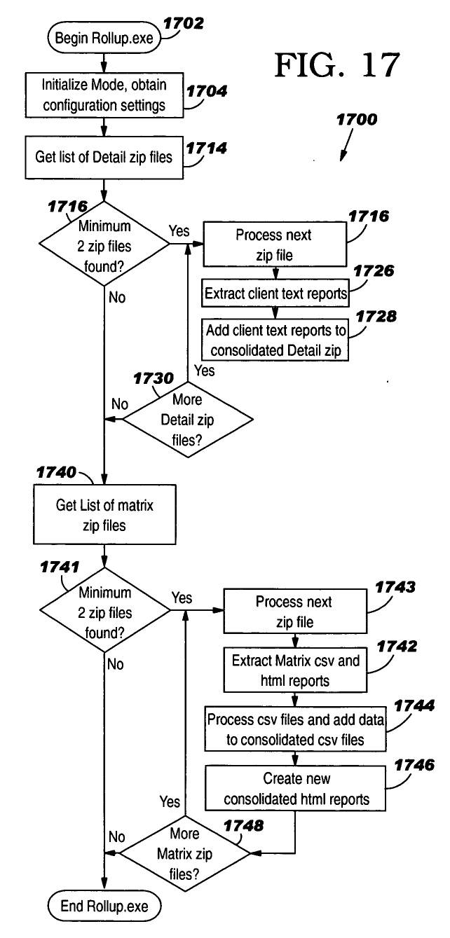

The Rollup exec 1700 is used to consolidate multiple reports generated by the Detail exec and Matrix exec from multiple Site Servers. FIG. 17 illustrates the Rollup exec in more detail. In step 1702, the site management/Patch Program 200 begins the Rollup (Rollup.exe) exec. Then, the Rollup exec initializes itself by setting the global variables the exec will use and obtains configuration settings that were generated by Program 200 (step 1704). Then, the Rollup exec obtains from the Site Server a list of the zip files generated by the Detail exec (step 1714). Then, the Rollup exec determines if there are at least two such zip files (decision 1716). If so, the Rollup exec processes the each zip file (step 1718). Then, the Rollup exec extracts client text reports from the zip file (step 1726). Then, the Rollup exec adds these client text reports to a consolidated zip file (step 1728). Then, the Rollup exec determines if there are any more zip files generated by the Detail exec (decision 1730). If so, the Rollup exec loops back to steps 1718, 1726, and 1728 to perform the foregoing consolidation as described above. After all the zip files generated by the Detail exec have been processed and consolidated, the Rollup exec obtains from the Site Server a list of zip files generated by the Matrix exec (step 1740). If there are at least two such zip files generated by the Matrix exec (decision 1741, yes branch), then the Rollup exec processes each zip file (step 1742). Then, the Rollup exec extracts CSV and HTML reports (generated by the Matrix exec) within the zip file (step 1742). Then, the Rollup exec consolidates this CSV data with other such CSV data into a consolidated CSV data file (step 1744). Then, from the HTML report in the zip file, the Rollup exec creates a new consolidated HTML report (step 1746). If there are any more zip files generated by the Matrix exec that have not yet been considered (decision 1748, yes branch), then the Rollup exec loops back to steps 1742, 1744 and 1746 to process these additional zip files in the manner described above.

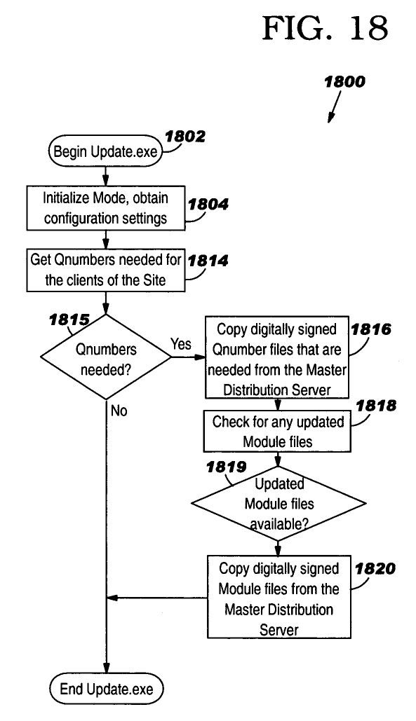

The Update exec 1800 downloads from the Master Distribution Server 116 via the Web Reporting Server 114 to the Site Server 110 digitally signed updates for the execs 400, 500, 600, 700, 800, 900, 1000, 1100, 1200, 1300, 1400, 1500, 1600, 1700 and 1800 (also called “Module” files). The Update exec 1800 also downloads from the Master Distribution Server 116 via the Web Reporting Server 114 to the Site Server 110 software updates in the form of security hotfixes, software patches and service packs that are needed by the Remote Client Servers of the Customer Site. FIG. 18 illustrates the Update exec 1800 in more detail. In step 1802, the site management/Patch Program 200 begins the Update (Update.exe) exec. Then, the Update exec initializes itself by setting the global variables the Update exec will use and obtains configuration settings that were generated by Program 200 (step 1804). Then, the Update exec obtains from the Site Server the Qnumbers or other software update identifiers of security hotfixes and software patches that are needed by the Remote Client Servers at the Customer Site (step 1814). Then, the Update exec determines if there are any such software identifiers (decision 1815). If so, then the Update exec downloads from the Master Distribution Server the digitally signed files that are needed by the Remote Client Servers (step 1816). (These will be staged and installed by the respective Stage exec and Install exec as described above.) Then, the Update exec determines if there are any updates available for the execs 400, 500, 600, 700, 800, 900, 1000, 1100, 1200, 1300, 1400, 1500, 1600, 1700 or 1800 (decision 1819). If so, the Update exec downloads the updates for the execs from the Master Distribution Server 118 (step 1820). (These will be updated the next time Program 200 is executed and DoServerVersionCheck process 2200 executes as described above.)

The InitializelNI program process 212 maintains, manages, creates, and obtains configuration settings from one or more ini files that are readable or encrypted for additional security. The InitializeIni process also introduces a template ini concept that allows for the use of replaceable variables within the template ini allowing the template to work in the specific server environment. The template ini allows for the Program 200 default ini to be automatically configured and created during the initial install. The template ini allows for any new settings to be automatically added to the Program 200 default ini and any other custom ini files that the System Administrator has created. The InitializeInI process allows any updates or upgrades of the Program 200 that require new settings to be implemented transparently without requiring the System Administrator to manually modify any configuration. The InitializeINI process allows the Program 200 to be executed using the command line interface to override configuration settings eliminating the need for a system administrator to modify the configuration file. FIG. 21 illustrates the InitializelNI process 212 in more detail. In step 2102, the InitializelNI process begins execution when called by Program 200. Then, the InitializelNI process locates a configuration file to use (default or custom) for Program 200 (step 2104). If the configuration file is found (decision 2106, yes branch), then the InitializelNI process checks for a newer template (step 2110). If there is such a newer template (decision 2111, yes branch), then the InitializelNI process updates the default configuration and all custom configurations with the new settings (step 2112). If there was not a newer template (decision 2111, no branch), then the InitializelNI process stores the input entries for the INI sections into an array in memory (step 2114). Then, the InitializelNI process initializes all settings in the specified ini file needed by the Program 200 to execute (step 2118). Referring again to decision 2106, no branch where the applicable configuration file was not found, then the InitializelNI process locates the template INI file (step 2108). If the template INI file is found (decision 2122, yes branch), then the InitializelNI process creates a default Ini from the template ini to be used be Program 200 (step 2120). If the template INI file is not found (decision 2122, no branch), then the InitializeINI process logs an error.

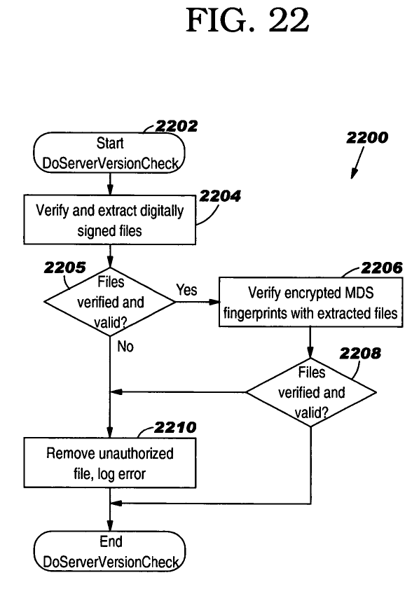

The DoServerVersionCheck program process 220 verifies and extracts the contents of digitally signed files and verifies AES encrypted MDF fingerprints for the Site Server 110. The DoServerVersionCheck process verifies and validates the authenticity, security, and integrity of all updates to the execs 200, 400, 500, 600, 700, 800, 900, 1000, 1100, 1200, 1300, 1400, 1500, 1600, 1700 or 1800 for the Site Server, and to the security hotfixes, software patches and service packs needed by the Remote Client Servers before distribution to the Remote Client Servers. Thus, the DoServerVersionCheck program process prevents rogue software files from being incorporated into or replacing existing software files that do not originate from an authorized source such as the Master Distribution Server 116. If the DoServerVersionCheck process detects a non compliant software file, the DoServerVersionCheck process removes this software file and logs an error. FIG. 22 illustrates the DoServerVersionCheck process 220 in more detail. In step 2202, the DoServerVersionCheck process begins to execute when called by Program 200. Then, the DoServerVersionCheck process verifies and extracts the contents of any digitally signed files that have been downloaded from the Web Reporting Server (step 2204). If a file is not successfully verified or is not valid, then the DoServerVersionCheck process removes the file and logs an error (step 2210). However, if the file is successfully verified and is valid (decision 2205, yes branch), then the DoServerVersionCheck process verifies encrypted MD5 fingerprints with the extracted files (step 2206). If the files are not successfully verified and valid (decision 2208, no branch), then the DoServerVersionCheck process removes the unauthorized file and logs an error (step 2210).

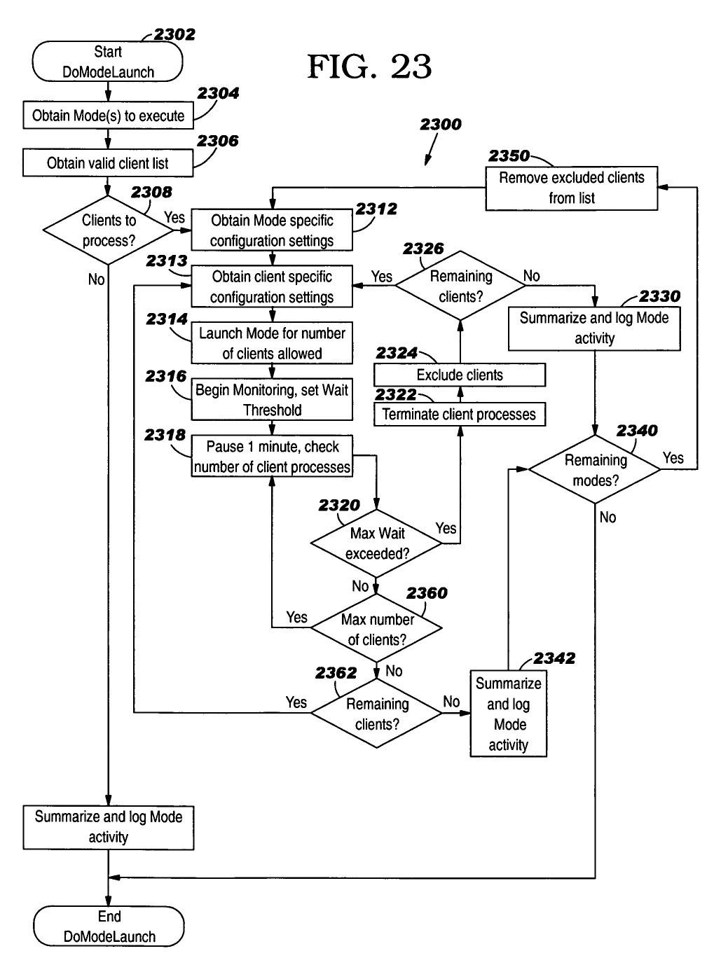

FIG. 23 illustrates the DoModeLaunch program process 224 in more detail. In step 2302, the DoModeLaunch process begins to execute when called by Program 200. Then, the DoModeLaunch process obtains each of the selected execs 400, 500, 600, 700, 800, 900, 1000, 1100, 1200, 1300, 1400, 1500, 1600, 1700 or 1800 to be executed (step 2304). Then, the DoModeLaunch process obtains from the Site Server the list of Remote Client Servers at the Customer Site 102 (step 2306). If there are any Remote Client Servers in the list (decision 2308, yes branch), then the DoModeLaunch process obtains from the Site Server the configuration settings that are specific to the respective execs (step 2312). Then, the DoModeLaunch process obtains the Remote Client Server specific configuration settings for each Remote Client Server for this exec (step 2313). Then, the DoModeLaunch process launches one image or copy of the selected exec for each of the Remote Client Servers (up to a limit) applying the applicable configuration settings (step 2314). Then, the DoModeLaunch process monitors progress of the exec for the Remote Client Servers, and sets a wait threshold such as ten minutes establishing a maximum time to wait for completion of execution of the exec for the allowed number of Remote Client Servers (step 2316). Then, the DoModeLaunch process waits the polling interval of one minute, and checks the Site Server for the number of remaining execs running for the Remote Client Servers (step 2318). If the maximum wait has been exceeded by any of the execs in any of the Remote Client Servers (decision 2320, yes branch), then the DoModeLaunch process terminates the exec for this Remote Client Server (step 2322) and then excludes the Remote Client Server for processing by any other execs (step 2324). If there are other Remote Client Servers that have not yet been processed (decision 2326, yes branch), then the DoModeLaunch process loops back to steps 2313, 2314, 2316, 2318, 2320, 2322 and 2324 to process them in a similar manner. After all the Remote Client Servers have been processed by this exec, and other execs remain to be executed (decision 2340, yes branch) then the DoModeLaunch process removes excluded Remote Client Servers from the list generated in step 2306 (step 2350), loops back to step 2312 to process the additional, nonexcluded Remote Client Servers in the manner described above. Referring again to decision 2320 no branch, where the maximum wait has not been exceeded for the exec for any of the Remote Client Servers, the DoModeLaunch process determines if the maximum number of Remote Client Servers are running the exec (decision 2360). If so, the DoModeLaunch process waits one minute (step 2318), and determines if the maximum wait threshold has been exceeded proceeds to decision 2320 as described above. If not, the DoModeLaunch process determines if there are any remaining Remote Client Servers that have not yet been processed by the current exec (decision 2364). If so, the DoModeLaunch process loops back to step 2312 (decision 2366, yes branch) to process these remaining Remote Client Servers in the manner described above. If not, the DoModeLaunch process summarizes and logs the results of execution of this exec (step 2342) and loops back to decision 2340 to resume processing in the manner described above.

FIG. 24 illustrates a text report generated by the Detail exec for a Remote Client Server called “CLIENT4”. The report includes a statement 2402 indication that it is excluded from the report at the request of the systems administrator. The report also includes a statement 2404 that a specified software program needs a patch or update but the patch is not installed. The report also includes a statement 2406 that another specified software program needs a patch or update but there is a warning. The report also includes a statement 2408 that a specified software patch has been installed but there is a note. The report also includes a statement 2410 that a specified software patch is installed.

FIG. 25 illustrates a report generated by the Matrix exec for “missing” Qnumbers The report indicates a summarized status of all Remote Client Servers of the Site Server including all staging and install activities allowed by the system administrator.

FIG. 26 illustrates an alternate embodiment where the Master Distribution Server is combined with the Site Server into a combination Master Distribution/Site Server 134. This may be desirable when there is a single customer network and local administration. Combination server 134 is connected to the Internet 108 for downloading security hotfixes, patches, and service packs. The functions of the Master Distribution Server within the combination server 134 are the same as the remote Master Distribution Server 116. Also, the functions of the Site Server within the combination server 134 are the same as those in the Site Server 110. FIG. 26 illustrates only a single Remote Client Server 112, although typically there are many.

FIG. 27 illustrates another, alternate embodiment comprising a Remote Client Server 112 and a mobile Site Server 144 which is used to connect to various customer networks. The mobile Site Server 144 is similar in function to Site Server 110 except that the Mobile Site Server does not support the Stage exec, Install exec, Remove exec, or Reboot exec. By way of example, these are not supported for this type of install as the mobile Site Server is typically a laptop computer that does not have adequate hardware resources to support the above execs. If a mobile Site Server has adequate hardware resources and connectivity to the Internet 108, then the embodiment illustrated in FIG. 26 is recommended.

Based on the foregoing, system, method and computer program product for automating installation of software updates have been disclosed. However, numerous modifications and substitutions can be made without deviating from the scope of the present invention. Therefore, the present invention has been disclosed by way of illustration and not limitation, and reference should be made to the following claims to determine the scope of the present invention.

1. A system for distributing updates to software in a plurality of client servers, said system comprising:
a client management server including a first program to determine what updates to said software are needed for installation at each of said client servers; and
a distribution server to obtain the needed software updates from one or more software vendors and furnish said needed software updates to said client management server; and wherein
said client management server further includes a second program to install the needed software updates at said client servers, a third program to determine what updates to said first program are needed for installation at said client management server, and a fourth program to install the needed program updates at said client management server; and
said distribution server furnishes the needed program updates to said client management server.

2. A system as set forth in claim 1 wherein said second program comprises a plurality of execs.

3. A system as set forth in claim 1 wherein said distribution server obtains the needed software updates via the Internet, and further comprising a firewall between the distribution server and the client management server.

4. A computer program product for distributing updates to software in a plurality of client servers, said computer program product comprising:
a computer readable medium;
first program instructions for execution in a client management server to determine what updates to said software are needed for installation at each of said client servers;
second program instructions for execution in a distribution server to obtain the needed software updates from one or more software vendors and furnish said needed software updates to said client management server;
third program instructions for execution in said client management server to install the needed software updates at said client servers;
fourth program instructions for execution in said client management server to determine what updates to said first program instructions are needed for installation at said client management server;
fifth program instructions for execution in said client management server to install the needed updates to said first program instructions at said client management server; and
sixth program instructions for execution in said distribution server to furnish the needed updates to said first program instructions to said client management server; and wherein said first, second, third, fourth, fifth and sixth program instructions are recorded on said medium.

5. A system for simulating distribution of updates to software in a plurality of client servers, said system comprising:
a client management server including a first program to determine what software is supported in each of said client servers and a second program to determine what updates to said software are needed for installation at each of said client servers; and
a distribution server to obtain the needed software updates from one or more software vendors and furnish said needed software updates to said client management server; and wherein
said client management server further includes a third program to determine if said needed software updates obtained from said distribution server are authentic, and a fourth program to log results of the determination by said first program of what software is supported in each of said client servers and results of the determination by said third program if said needed software updates obtained from said distribution server are authentic, display said log to a user before said needed software updates are installed in said client servers, and allow said user to avoid said installation based on said log.

6. A computer program product for simulating distribution of updates to software in a plurality of client servers, said computer program product comprising:
a computer readable medium;
first program instructions for execution in a client management server to determine what software is supported in each of said client servers;
second program instructions for execution in said client management server to determine what updates to said software are needed for installation at each of said client servers;
third program instructions for execution in a distribution server to obtain the needed software updates from one or more software vendors and furnish said needed software updates to said client management server;
fourth program instructions for execution in said client management server to determine if said needed software updates obtained from said distribution server are authentic;
fifth program instructions for execution in said client management server to log results of the determination by said first program instructions of what software is supported in each of said client servers and results of the determination by said fourth program instructions if said needed software updates obtained from said distribution server are authentic, display said log to a user before said needed software updates are installed in said client servers, and allow said user to avoid said installation based on said log; and wherein
said first, second, third, fourth and fifth program instructions are recorded on said medium.

7. A system for distributing updates to common software in a group of client servers, said system comprising:
a client management server including a first program to determine what updates to said common software are needed for installation at each of said client servers in said group; and
a distribution server to obtain the needed software updates from one or more software vendors and furnish said needed software updates to said client management server; and wherein
said client management server further includes a second program to install the needed software updates at said client servers in said group and automatically reboot at different times said client servers in said group to activate said installed, needed software updates such that all of said client servers in said group are not rebooting at the same time, whereby availability of said common software to users from at least one of said client servers in said group is maintained.

8. A computer program product for distributing updates to common software in a group of client servers, said computer program product comprising:
a computer readable medium;
first program instructions for execution in a client management server to determine what updates to said common software are needed for installation at each of said client servers in said group;
second program instructions for execution in a distribution server to obtain the needed software updates from one or more software vendors and furnish said needed software updates to said client management server;
third program instructions for execution in said client management server to install the needed software updates at said client servers in said group and automatically reboot at different times said client servers in said group to activate said installed, needed software updates such that all of said client servers in said group are not rebooting at the same time, whereby availability of said common software to users from at least one of said client servers in said group is maintained; and wherein said first, second and third program instructions are recorded on said medium.
